(19) United States
(12) Patent Application Publication
(10) Pub. No.: US 2026/0081941 A1
(43) Pub. Date: Mar. 19, 2026

(54) SERVER DEVICE FOR SUPPORTING ANOMALY PERIOD DETECTION AND OPERATING METHOD THEREOF

(71) Applicant: KOREA ELECTRONICS TECHNOLOGY INSTITUTE, Seongnam-si (KR)

(72) Inventors: Min Goo LEE, Seoul (KR); Yong Kuk PARK, Seoul (KR); Tae Heon NO, Seoul (KR)

(21) Appl. No.: 19/035,587

(22) Filed: Jan. 23, 2025

(30) Foreign Application Priority Data
Sep. 13, 2024 (KR) 10-2024-0125500

(51) Int. Cl. H04L 9/40

(52) U.S. Cl. CPC H04L 63/1425

(57) ABSTRACT

A server device is proposed. The device may support anomaly period detection. The server device may receive sensor data from a sensor and produce smoothing period data by performing preprocessing on the sensor data based on an anomaly period detection model corresponding to the sensor. The server device may also acquire recovery data by inputting the smoothing period data into the anomaly period detection model. The server device may further determine a normal period pattern or an anomaly period pattern by comparing an error calculated between the smoothing period data and the recovery data with a predetermined threshold.

### CROSS REFERENCE TO RELATED APPLICATION

The present application claims priority to Korean Patent Application No. 10-2024-0125500 filed on Sep. 13, 2024 in the Korean Intellectual Property Office, the entire contents of which are incorporated herein for all purposes by this reference.

### BACKGROUND

### Technical Field

The present disclosure relates to a data anomaly period detection technique capable of recognizing and responding to data loss.

### Description of Related Technology

In the Internet of Things (IoT) field, anomaly detection systems are emerging as an important task to respond to data quality management threats that arise from unstable interaction environments between sensors and external nodes.

### SUMMARY

One aspect is an anomaly detection technology that utilizes a statistical-based artificial intelligence (AI) model so as to overcome the limitations of manpower and time costs of typical anomaly detection systems.

Another aspect is a device and method capable of implementing improved anomaly period detection by integrating a statistical analysis technique, an unsupervised learning-based neural network model, and an AutoEncoder model.

Another aspect is a device and method for anomaly period detection by integrating a statistical-based period filtering (SAPEF) designed based on results derived from communication period analysis with an AutoEncoder while improving disadvantages of statistical analysis and an AI model and maximizing their advantages.

Another aspect is a server device that supports anomaly period detection is provided. The server device includes a communication circuit receiving sensor data from a sensor, a memory storing the received sensor data and an anomaly period detection model, and at least one processor functionally connected to the communication circuit and the memory. The memory may store at least one instruction executed by the at least one processor. The at least one instruction may be configured to cause, when executed, the server device to receive the sensor data from the sensor, produce smoothing period data by performing preprocessing on the sensor data based on the anomaly period detection model corresponding to the sensor, acquire recovery data by inputting the smoothing period data into the anomaly period detection model, and determine a normal period pattern or an anomaly period pattern by comparing an error calculated between the smoothing period data and the recovery data with a predetermined threshold.

In the server device, the at least one instruction may be configured to determine the threshold by summing up an average and a standard deviation of the errors between the smoothing period data and the recovery data, and the error may include a mean absolute error per element of a set of the recovery data and the smoothing period data.

In the server device, the at least one instruction may be configured to determine a case where a value of the error is greater than the threshold as occurrence of the anomaly period pattern, and determine a case where the value of the error is less than the threshold as occurrence of the normal period pattern.

In the server device, the at least one instruction may be configured to create a detection alarm message indicating the anomaly period pattern in response to the occurrence of the anomaly period pattern, and transmit the detection alarm message to a user terminal of an administrator who manages the sensor.

In the server device, the at least one instruction may be configured to create a detection report on the anomaly period detection, and transmit the detection report to a user terminal of an administrator who manages the sensor.

In the server device, the at least one instruction may be configured to perform a validity check on the sensor data, upon receiving the sensor data, and then store the sensor data in the memory.

Another aspect is an operating method of a server device that supports anomaly period detection is provided. The method includes receiving sensor data from a sensor; producing smoothing period data by performing preprocessing on the sensor data based on an anomaly period detection model corresponding to the sensor; acquiring recovery data by inputting the smoothing period data into the anomaly period detection model; and determining a normal period pattern or an anomaly period pattern by comparing an error calculated between the smoothing period data and the recovery data with a predetermined threshold.

In the method, the error may include a mean absolute error per element of a set of the recovery data and the smoothing period data, and the method may further include determining the threshold by summing up an average and a standard deviation of the errors between the smoothing period data and the recovery data.

In the method, determining may include determining a case where a value of the error is greater than the threshold as occurrence of the anomaly period pattern, and determining a case where the value of the error is less than the threshold as occurrence of the normal period pattern.

The method may further include creating a detection alarm message indicating the anomaly period pattern in response to the occurrence of the anomaly period pattern, and transmitting the detection alarm message to a user terminal of an administrator who manages the sensor.

The method may further include creating a detection report on the anomaly period detection, and transmitting the detection report to a user terminal of an administrator who manages the sensor.

The method may further include performing a validity check on the sensor data, upon receiving the sensor data, and then storing the sensor data in the memory.

According to the present disclosure, it is possible to verify the accuracy and reliability through significant accuracy, precision, and recall evaluated in an experiment conducted based on actual residential information data collected by the sensor in unstable and stable environments, and it is also possible to provide a realistic operation scenario utilizing the same.

### BRIEF DESCRIPTION OF THE DRAWINGS

FIG. 1 is a diagram showing an example of a statistical-based period filtering and AI modeling system according to an embodiment of the present disclosure.

FIG. 2 is a diagram showing an example of a use case for learning and detection of a statistical-based period filtering and AI model according to an embodiment of the present disclosure.

FIG. 3 is a diagram showing an example of information stored in a database of a statistical-based period filtering system according to an embodiment of the present disclosure.

FIG. 4 is a diagram showing an example of a statistical-based period filtering and AI model learning method according to an embodiment of the present disclosure.

FIG. 5 is a diagram showing an example of operation of a server device related to collection of sensor data according to an embodiment of the present disclosure.

FIG. 6 is a diagram showing an example of execution timing of an anomaly period detection model according to an embodiment of the present disclosure.

FIG. 7 is a diagram showing an example of a connection point of a detection process according to an embodiment of the present disclosure.

FIG. 8 is a diagram showing an example of a statistical-based period filtering method according to an embodiment of the present disclosure.

FIG. 9 is a diagram showing an example of a preprocessing process according to an embodiment of the present disclosure.

FIG. 10 is a diagram showing an example of a period collection list of an IoT sensor according to an embodiment of the present disclosure.

FIG. 11 is a diagram showing an example of a collected data storage object according to an embodiment of the present disclosure.

FIG. 12 is a diagram showing an example of preprocessing of period of raw data according to an embodiment of the present disclosure.

FIG. 13 is a diagram showing an example of anomaly phenomenon classification based on control boundary according to an embodiment of the present disclosure.

FIG. 14 is a diagram showing an example of period data visualization according to period data smoothing.

FIG. 15 is a diagram showing another example of period data visualization according to period data smoothing.

FIG. 16 is a diagram showing an example of a smoothing preprocessing method according to an embodiment of the present disclosure.

FIG. 17 is a diagram showing an example of setting a parsing time list according to an embodiment of the present disclosure.

FIG. 18 is a diagram showing an example of setting a smoothing period list according to an embodiment of the present disclosure.

FIG. 19 is a diagram showing an example of comparing original period data and smoothing period data according to an embodiment of the present disclosure.

FIG. 20 is a diagram showing another example of comparing original period data and smoothing period data according to an embodiment of the present disclosure.

FIG. 21 is a diagram showing an example of adjusting the intensity of smoothing preprocessing according to an embodiment of the present disclosure.

FIG. 22 is a diagram showing an example of an average variance value of point data by smoothing period pattern according to an embodiment of the present disclosure.

FIG. 23 is a diagram showing an example of data related to direction preprocessing according to an embodiment of the present disclosure.

FIG. 24 is a diagram showing an example of an average variance value of point data by direction period pattern according to an embodiment of the present disclosure.

FIG. 25 is a diagram showing an example of a filtering process according to an embodiment of the present disclosure.

FIG. 26 is a diagram showing an example of initializing a labeling information list according to an embodiment of the present disclosure.

FIG. 27 is a diagram showing an example of applying a sliding window according to an embodiment of the present disclosure.

FIG. 28 is a diagram showing an example of applying point labeling according to an embodiment of the present disclosure.

FIG. 29 is a diagram showing an example of a projection step according to an embodiment of the present disclosure.

FIG. 30 is a diagram showing an example of a separation step according to an embodiment of the present disclosure.

FIG. 31 is a diagram showing an example of an AutoEncoder applied to an anomaly period detection model according to an embodiment of the present disclosure.

FIG. 32 is a diagram showing an example of input/output of an AutoEncoder according to an embodiment of the present disclosure.

FIG. 33 is a diagram showing an example of an anomaly period detection method using an AutoEncoder with learning completed according to an embodiment of the present disclosure.

FIG. 34 is a diagram showing an example of a method for connecting a statistical-based period filtering model and an AutoEncoder model according to an embodiment of the present disclosure.

FIG. 35 is a diagram showing an example of a neural network configuration of an AutoEncoder when a period value is 8 according to an embodiment of the present disclosure.

FIG. 36 is a diagram showing an example of a data separation process for AutoEncoder learning according to an embodiment of the present disclosure.

FIG. 37 is a diagram showing an example of a threshold setting method according to an embodiment of the present disclosure.

FIG. 38 is a diagram showing an example of a performance evaluation method according to an embodiment of the present disclosure.

FIG. 39 is a diagram showing an example of a labeling method according to an embodiment of the present disclosure.

FIG. 40 is a diagram showing an example of interpretation by classification performance metrics cases in anomaly detection according to an embodiment of the present disclosure.

FIG. 41 is a diagram showing another example of interpretation by classification performance metrics cases in anomaly detection according to an embodiment of the present disclosure.

FIG. 42 is a diagram showing an example of interpretation by classification performance metrics in anomaly detection according to an embodiment of the present disclosure.

FIG. 43 is a diagram showing an example of an experimental environment related to an experiment and performance analysis based on residential information data using an anomaly period detection model according to an embodiment of the present disclosure.

FIG. 44 is a diagram showing an example of preprocessing data in an unstable duration in the experimental environment shown in FIG. 43.

FIG. 45 is a diagram showing an example of a sliding window main section in an unstable duration in an experimental environment according to an embodiment of the present disclosure.

FIG. 46 is a diagram showing the degree of instability in an experimental environment according to an embodiment of the present disclosure.

FIG. 47 is a diagram visualizing an anomaly period occurrence duration of statistical-based period filtering according to an embodiment of the present disclosure.

FIG. 48 is a diagram expressing as text an anomaly period occurrence duration of statistical-based period filtering according to an embodiment of the present disclosure as text.

FIG. 49 is a diagram showing an AutoEncoder learning evaluation according to an embodiment of the present disclosure.

FIG. 50 is a diagram showing an example of recovery threshold setting values in an unstable duration according to an embodiment of the present disclosure.

FIG. 51 is a diagram comparing normal and anomaly data recovery visualizations in an unstable duration according to an embodiment of the present disclosure.

FIG. 52 is a diagram showing an example of classification metrics in an unstable duration according to an embodiment of the present disclosure.

FIG. 53 is a diagram showing an example of patterns by cases in an unstable duration according to an embodiment of the present disclosure.

FIG. 54 is a diagram showing average pattern variance values by cases in an unstable duration according to an embodiment of the present disclosure.

FIG. 55 is a diagram showing an example of preprocessing data in a stable duration in the experimental environment shown in FIG. 43.

FIG. 56 is a diagram showing an example of a comparison of normal and anomaly period patterns in a stable duration in an experimental environment according to an embodiment of the present disclosure.

FIG. 57 is a diagram showing an emphasis on anomaly period patterns in a stable duration in an experimental environments according to an embodiment of the present disclosure.

FIG. 58 is a diagram showing an example of recovery threshold setting values in a stable duration according to an embodiment of the present disclosure.

FIG. 59 is a diagram showing an example of classification metrics in a stable duration according to an embodiment of the present disclosure.

FIG. 60 is a diagram showing an example of patterns by cases in a stable duration according to an embodiment of the present disclosure.

FIG. 61 is a diagram showing average pattern variance values by cases in a stable duration according to an embodiment of the present disclosure.

FIG. 62 is a diagram showing an active model list among actually applied screens of an anomaly period detection model according to an embodiment of the present disclosure.

FIG. 63 is a diagram showing an example of a model learning setting console among actually applied screens of an anomaly period detection model according to an embodiment of the present disclosure.

FIG. 64 is a diagram showing an example of a SAPEF input/output information screen among actually applied screens of an anomaly period detection model according to an embodiment of the present disclosure.

FIG. 65 is a diagram showing an example of an AutoEncoder learning and evaluation information screen among actually applied screens of an anomaly period detection model according to an embodiment of the present disclosure.

FIG. 66 is a diagram showing an example of a detection report list screen among actually applied screens of an anomaly period detection model according to an embodiment of the present disclosure.

FIG. 67 is a diagram showing an example of a detection report screen among actually applied screens of an anomaly period detection model according to an embodiment of the present disclosure.

FIG. 68 is a diagram showing another example of a detection report screen among actually applied screens of an anomaly period detection model according to an embodiment of the present disclosure.

FIG. 69 is a diagram showing yet another example of a detection report screen among actually applied screens of an anomaly period detection model according to an embodiment of the present disclosure.

FIG. 70 is a diagram showing an example of a detection alarm screen among actually applied screens of an anomaly period detection model according to an embodiment of the present disclosure.

FIG. 71 is a diagram showing another example of a detection alarm screen among actually applied screens of an anomaly period detection model according to an embodiment of the present disclosure.

### DETAILED DESCRIPTION

The IoT sensor performs measurement and communication with a limited amount of resources due to its device nature, and anomaly phenomena that occur due to this limitation affect measurement accuracy and transmission quality. In addition, a wireless communication network, which is the medium of interaction between the IoT sensor and a server, has the characteristics of an open environment compared to a wired network composed of physical links, and is therefore exposed to various threats. Meanwhile, the server performs a request from the IoT sensor and transmits a response, and if there is a loss or corruption of response data due to communication or server problems, the possibility of potential errors of the sensor may be increased.

To solve these problems, research is being conducted in the IoT field on anomaly detection systems to quickly discover and respond to internal/external problems between the sensor and the server. The anomaly detection systems are one of the important technologies for data quality management and may be divided into manual and automatic detection systems depending on whether or not human intervention is involved.

The manual anomaly detection system is a monitoring system that performs real-time control and correction of accumulated sensing data by mobilizing manpower. Because of limited manpower and time cost, the manual anomaly detection system has the disadvantage of being difficult to accurately detect and respond in real time. The automatic anomaly detection system is a system that performs anomaly detection based on data utilizing statistical analysis and an artificial intelligence (AI) model without mobilizing manpower. Statistical analysis is a traditional anomaly detection technique that performs anomaly detection based on statistics. Since the detection process is configured based on domain knowledge, it has the advantage of having few limitations related to the composition of data, but has the disadvantage of having a large limitation in feature extraction for normal data. The anomaly detection technique based on the AI model mainly utilizes deep learning technology based on a neural network with high feature extraction intensity. Depending on the composition of learning data, AI models are classified into supervised and unsupervised learning models, and the unsupervised learning model that learns using only normal data is mainly used in the field of anomaly detection.

However, anomaly data, which is very small in quantity compared to normal data, is likely to be mixed with normal data, and this situation hinders the smooth learning and evaluation of the model, making it difficult to verify the reliability of actual operability. To solve this problem, labeling work must be performed like the supervised learning model, but this also incurs high manpower and time costs like conventional statistical analysis.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

An anomaly period detection technique of the present disclosure can solve potential error problems in the IoT network environment and automatically support the anomaly detection of collected data in the system without the intervention of an administrator. In addition, the anomaly period detection technique of the present disclosure can support the anomaly detection function without background knowledge of the domain of the IoT network. Further, the anomaly period detection technique of the present disclosure is based on the unsupervised learning model, thus reducing the manpower and time costs incurred due to labeling work.

An anomaly detection model of the present disclosure is designed to complement the shortcomings of a statistical analysis technique and an AI model. That is, the anomaly period detection technique of the present disclosure utilizes a statistical-based AI model that integrates a statistical analysis technique and an AI model in an in-building wireless sensor network environment. Specifically, the anomaly period detection model of the present disclosure is a learning-completed statistical-based period filtering and AI model and is composed of statistical-based period filtering (SAPEF) that realizes labeling automation by utilizing a statistical analysis technique, and an AutoEncoder (AE) that utilizes labeled data for learning and evaluation. The data used in the present disclosure is measurement data of a sensor installed in a building to collect residential information. To detect anomalies in a wireless sensor network, timestamp information of the measurement data is extracted, and preprocessed period data is used as input to the statistical-based AI model (or referred to as SAPEF-AE model).

Hereinafter, the design of a statistical-based period filtering (SAPEF) including preprocessing and labeling automation, the design of an AutoEncoder (AE) neural network having connectivity with hyper-parameters of the SAPEF, and a statistical-based AI model (or referred to as SAPEF-AE model) constructed through such designs will be described. In addition, the accuracy and reliability of actual operability will be discussed through learning and evaluation results using actually collected data.

The disclosure supports securing the accuracy and reliability for data collected through IoT sensors, and makes it easy to detect error data for the IoT sensor data, thereby improving data management costs and required time. In addition, it can support a more accurate understanding of the on-site situation and appropriate responses thereto through quality improvement of environmental data collected in the field.

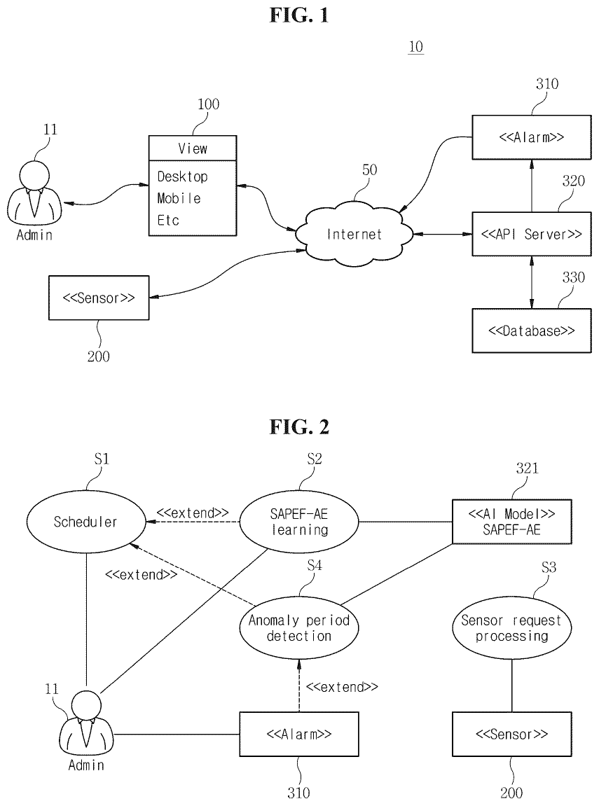

FIG. 1 is a diagram showing an example of a statistical-based period filtering and AI modeling system according to an embodiment of the present disclosure.

Referring to FIG. 1, the statistical-based period filtering and AI modeling system 10 may include a sensor 200, a user terminal 100, a network 50, a server device 320, a database 330, and an alarm device 310.

The sensor 200 is an IoT sensor to which the statistical-based period filtering and AI model is applied. For example, there may be at least one sensor (or a plurality of sensors) that collects residential information in a certain building. The sensor 200 is not limited to a specific type of sensor, and various types of sensors may be targets of the statistical-based period filtering and AI model. The sensor 200 may be configured to acquire sensor data based on an installed location according to a certain period and transmit the acquired sensor data to the server device 320. The sensor 200 may include a communication circuit for transmitting the acquired sensor data to the server device 320 and may transmit the sensor data through a communication channel formed with the server device 320. Alternatively, the sensor 200 may transmit the sensor data to the server device 320 through a hub.

The user terminal 100 may access the server device 320 via the network 50 and receive an alarm from the alarm device 310. The user terminal 100 may be at least one communication device among various communication devices such as a desktop computer, a mobile communication device, etc. The user terminal 100 may be held by an administrator 11 (or a user) or may be placed in a certain location where the administrator 11 can use it. Using the user terminal 100, the administrator 11 may access the server device 320 or the alarm device 310. The user terminal 100 may provide the administrator 11 with control regarding the creation of the statistical-based period filtering and AI model via a browser or a specific application. The administrator 11 may request learning of the statistical-based period filtering and AI model to the server device 320 via the user terminal 100. In relation to supporting the above-described functions, the user terminal 100 may include a communication circuit, a memory, a processor, a display, and an input/output device.

The network 50 may provide communication connection between the user terminal 100 and the server device 320 or the alarm device 310 and between the sensor 200 and the server device 320 or the alarm device 310. The network 50 may include various network components. For example, if the user terminal 100 is a mobile wireless terminal, the network 50 may include a base station, a base station controller, and a network interworking interface for communication with the user terminal 100. The network 50 may include at least one of a wired or wireless communication interface for signal transmission and reception of the sensor 200. The type or characteristics of the network 50 is not limited.

The server device 320 may include an application program interface (API) for learning and detection. Therefore, the server device 320 may also be referred to as an API server. The server device 320 may support the collection of data for learning of the statistical-based period filtering and AI model, the learning of the statistical-based period filtering and AI model using the collected data, and detection using the statistical-based period filtering and AI model with learning completed. In this regard, the server device 320 may collect data (e.g., period data) from the sensor 200 through the network 50 and store the collected data in the database 330. When a specified amount of data is stored, the server device 320 may perform the learning of the statistical-based period filtering and AI model. The server device 320 may perform anomaly detection on the data provided by the sensor 200 using the learning-completed statistical-based period filtering and AI model, and when anomaly data is detected, may transmit it to the alarm device 310. In addition, the server device 320 may receive setting information including a reference value (e.g., a hyper-parameter value or a setting value regarding a sensor collection range) for the learning of the statistical-based period filtering and AI model from the user terminal 100, and may perform data processing based on the received setting information. In relation to performing the above-described operations, the server device 320 may include at least one communication circuit supporting at least one communication scheme, a memory, an input/output interface, and at least one processor. The at least one processor may process at least one command (e.g., at least one command stored in the memory) related to creating the statistical-based period filtering and AI model and performing the anomaly detection function based on the created model which are performed by the server device 320.

The database 330 may store and manage various data required for the learning and detection of the statistical-based period filtering and AI model performed by the server device 320. In addition, the database 330 may store binary data of the statistical-based period filtering and AI model with learning completed. Information used in the learning process of the statistical-based period filtering and AI model stored in the above database 330 may also be used in the subsequent process of detecting anomaly occurring in the sensor 200.

Upon receiving the result of anomaly detection from the server device 320, the alarm device 310 may provide the result to the user terminal 100 (e.g., the user terminal owned by the administrator 11 of the sensor 200). In this regard, the alarm device 310 may store and manage necessary information (e.g., as contact information, a phone number, an IP address, or an application identification number) on the user terminal 100 so as to transmit an alarm message to the user terminal 100. For example, the alarm device 310 may support real-time alarm transmission using at least one of a messenger, a web socket, and a firebase which are installed in at least one user terminal 100 possessed or used by the administrator 11.

Although the statistical-based period filtering system 10 is described above in which the server device 320 and the alarm device 310 are separated, the present disclosure is not limited to the above description. Alternatively, the server device 320 and the alarm device 310 may be physically included in one electronic device and have two functionally distinguished modules, i.e., one module for performing the statistical-based period filtering function and another module for performing the alarm function based on anomaly detection. Alternatively, the module that performs the statistical-based period filtering function may be designed to perform the alarm function as well. Such module(s) may be configured at least in part as a software module or a hardware module. Similarly, the database 330 may be provided as a component separate from the server device 320 or a component integrated into the server device 320.

FIG. 2 is a diagram showing an example of a use case for learning and detection of a statistical-based period filtering and AI model according to an embodiment of the present disclosure.

Referring to FIGS. 1 and 2, the statistical-based period filtering and AI model learning (S2) and the anomaly period detection (S4) may be designed as a direct control scheme using a sensor management application installed in the user terminal 100 available to the administrator 11, and an automatic control scheme utilizing a scheduler (S1) and a server interaction process for the learning of the statistical-based period filtering and AI model between the sensor 200 and the server device 320.

In the case of the direct control scheme, the administrator 11 participates in the statistical-based period filtering and AI model learning (S2) by using the user terminal 100, and the reference value required for model learning may be input through the user terminal 100. In addition, when the administrator 11 transmits sensor request processing (S3) to the sensor 200 through the user terminal 100, and the sensor 200 transmits sensor data to the server device 320 in response to the sensor request processing (S3), the server device 320 may perform the statistical-based period filtering and AI model learning (S2) or perform the anomaly period detection (S4) based on a learning-completed statistical-based period filtering and AI model 321.

In the case of the automatic control scheme, the scheduler (S1) may support acquisition of sensor data of the sensor 200 according to scheduling information set by a designer. In addition, when the learning (S2) of the statistical-based period filtering and AI model is completed, the scheduler (S1) may support performing the anomaly period detection (S4) using the learning-completed statistical-based period filtering and AI model 321. The sensor 200 may perform the sensor request processing (S3) according to the period specified by the scheduler (S1) or the request specified by the administrator 11, and provide the sensor data to the server device 320.

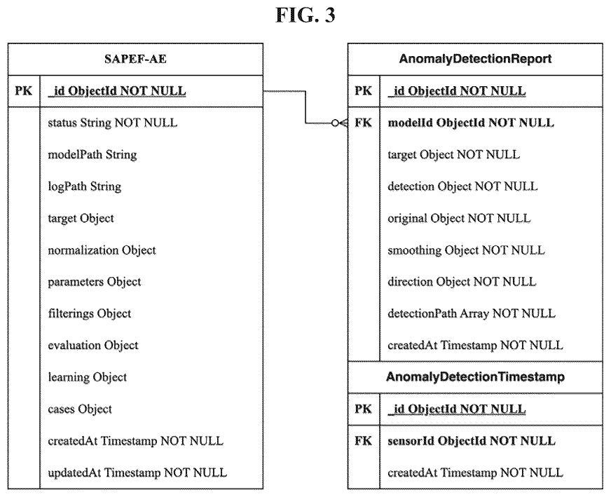

FIG. 3 is a diagram showing an example of information stored in a database of a statistical-based period filtering system according to an embodiment of the present disclosure.

Referring to FIGS. 1 to 3, the database 330 may store a statistical-based period filtering and AI model (SAPEF-AE) entity for storing input and output values generated during the learning process of the statistical-based period filtering and AI model 321, and also store an AnomalyDetectionReport entity and an AnomalyDetectionTimestamp entity for recording an anomaly detection pattern. The SAPEF-AE entity, the AnomalyDetectionReport entity, and the AnomalyDetectionTimestamp entity stored in the database 330 may be provided as analysis data of the detection activity performance of the learning-completed model and the anomaly detection results.

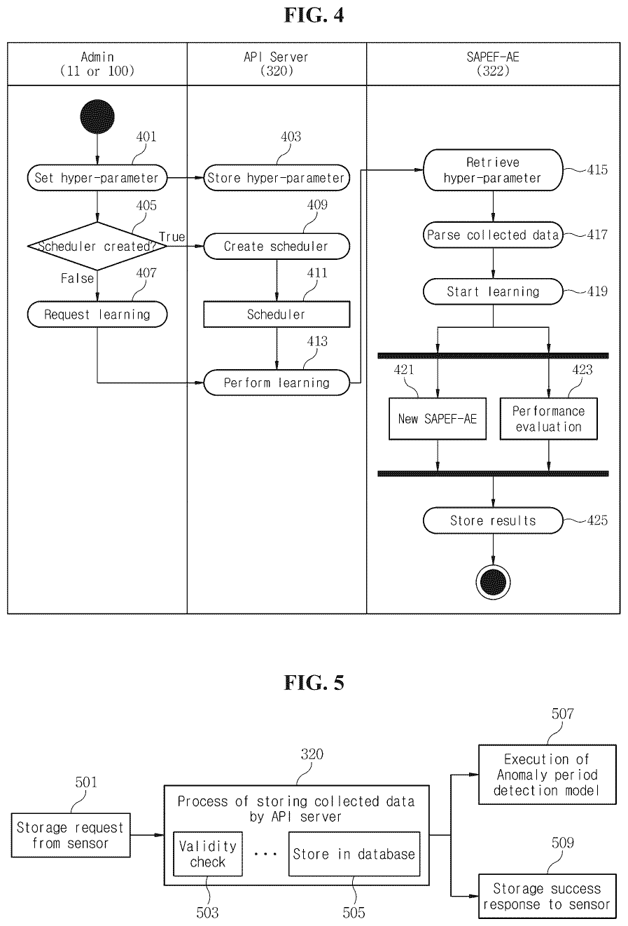

FIG. 4 is a diagram showing an example of a statistical-based period filtering and AI model learning method according to an embodiment of the present disclosure.

Referring to FIGS. 1 to 4, in the statistical-based period filtering and AI model learning method, a step 401 may be performed in which the administrator 11 sets hyper-parameters (e.g., freq, period, vt) for statistical-based period filtering and AI model learning by using the user terminal 100. In an actual operating environment, the step 401 may be a step of specifying a collection range of sensing data to be used as input for the statistical-based period filtering and AI model. Setting hyper-parameters (or specifying the data collection range) in the step 401 may be performed independently for each sensor, and after the setting is completed, the administrator 11 may request the statistical-based period filtering and AI model learning to create a model for the corresponding sensor. At this time, as a function for automatic learning, the scheduler (S1) may receive an execution cycle instead of a collection range in the setting of the hyper-parameters and periodically perform automatic learning on data accumulated during an idle time of the corresponding cycle. The model learning, performed in the server device 320 at the request of the administrator 11 or by the scheduler (S1), may be performed in the order of retrieving pre-stored hyper-parameters, parsing data collected based on the retrieved information, transferring the parsed data as an input to the statistical-based period filtering and AI model, preprocessing, statistical-based period filtering, and modeling.

Specifically, in the step 401, when a setting value for hyper-parameter setting is received by an input of the administrator 11, the user terminal 100 may transmit the hyper-parameter setting value to the server device 320, and the server device 320 may store the hyper-parameter in step 403.

When the hyper-parameter setting is completed, the user terminal 100 may check in step 405 whether the scheduler (S1) is created. If the scheduler (S1) is not created, the user terminal 100 may transmit a message for a learning request to the server device 320 in step 407. Upon receiving the learning request message from the user terminal 100, the server device 320 may perform the learning progress in step 413.

When a scheduler creation is requested in the step 405, the user terminal 100 may transmit a scheduler creation request message to the server device 320, and the server device 320 may perform a task for scheduler creation in step 409 and create the scheduler (S1) for the statistical-based period filtering and AI model learning in step 411. After the scheduler (S1) is created, the server device 320 may perform learning progress in step 413. In relation to the learning progress, the server device 320 may request a model creating processor 322 to perform model learning. The model creating processor 322 may be a part of the server device 320 and may perform processing for learning of the statistical-based period filtering and AI model to provide the learning-completed statistical-based period filtering and AI model.

When the model creating processor 322 receives the request for learning progress from the server device 320 (e.g., a main processor of the server device 320), the model creating processor 322 may retrieve the hyper-parameter related to the corresponding sensor 200 from the memory (or database 330) in step 415, and perform parsing of the data collected related to the corresponding sensor 200 (or sensor collection data, sensor data, collected data stored in the database 330) in step 417.

Next, the model creating processor 322 may start the statistical-based period filtering and AI model learning based on the parsed data in step 419, and create a new statistical-based period filtering and AI model in step 421 (or corresponding to the sensor). The model creating processor 322 may perform a performance evaluation on the new statistical-based period filtering and AI model in step 423, and then store and organize the performance evaluation results in step 425.

FIG. 5 is a diagram showing an example of operation of a server device related to collection of sensor data according to an embodiment of the present disclosure.

Referring to FIGS. 1 to 5, in relation to the collection of sensor data of the server device 320, the server device 320 may receive a storage request from the sensor 200 in step 501. In this regard, the sensor 200 may be configured to transmit the collected sensor data to the server device 320 at a certain period. Upon receiving the sensor data storage request from the sensor 200, the server device 320 that maintains a communication channel with the sensor 200 may extract the sensor data included in the request and perform a validity check in step 503. For example, the server device 320 may verify whether the received sensor data is data received from the pre-designated sensor 200. In addition, the server device 320 may perform a check to verify whether the sensor data is corrupted. If the sensor data satisfies a validity condition within a designated range, the server device 320 may store the sensor data in the database 330 in step 505.

Next, in step 507, the server device 320 may execute an anomaly period detection model (e.g., the statistical-based period filtering and AI model) and input the sensor data into the model to perform anomaly period detection. Additionally, in step 509, the server device 320 may transmit a response message regarding successful storage to the sensor 200. The steps 507 and 509 may be processed in parallel.

In relation to the sensor data collection, when the sensor data is received from the sensor 200, the server device 320 may asynchronously execute operations such as performing a processing process related to storage, sending a storage success response to the sensor 200 when the process is terminated, and inputting the stored data into the anomaly period detection model (or the learning-completed statistical-based period filtering and AI model).

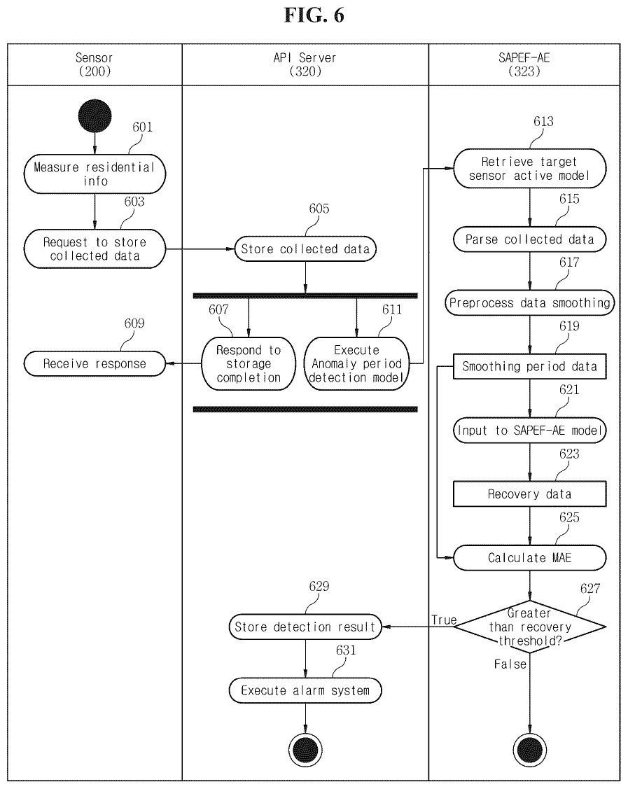

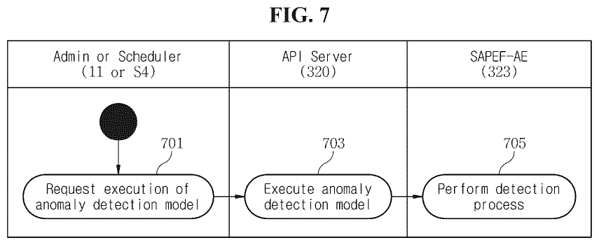

FIG. 6 is a diagram showing an example of execution timing of an anomaly period detection model according to an embodiment of the present disclosure.

Referring to FIGS. 1 to 6, in relation to the execution of the anomaly period detection model (or the learning-completed statistical-based period filtering and AI model), the sensor 200 may perform a residential information measurement operation in step 601. The residential information measurement operation is based on the type or characteristics of the sensor 200. That is, depending on the type or characteristics of the sensor 200, any other sensor data that matches the type or characteristics of the sensor 200 may be measured instead of residential information. When the residential information measurement is completed, the sensor 200 may perform a collected data storage request in step 603. In this regard, the sensor 200 may create a collected data storage request message, establish a communication channel with the server device 320, and then transmit the collected data storage request message to the server device 320.

The server device 320 may perform a collected data storage operation in step 605. The collected data storage operation may include data validity check and data storage in the database 330 as described above in FIG. 5.

Next, in step 607, the server device 320 may perform a storage completion response. In this regard, the server device 320 may create a storage completion response message and transmit the message to the sensor 200. The sensor 200 may receive the storage completion response transmitted by the server device 320 in step 609. The sensor 200 that receives the response may wait for a specified time and then re-perform the step 601 after the specified time has elapsed. Meanwhile, the server device 320 may execute the anomaly period detection model (or the statistical-based period filtering and AI model) in step 611. This step 611 may correspond to the above-described step 509 in FIG. 5.

As the anomaly period detection model is executed, a model operating processor 323 may retrieve a target sensor active model in step 613. In this regard, the model operating processor 323 may identify the identification information of the sensor 200 from the information transmitted by the sensor 200 and retrieve an active model related to the sensor 200 previously stored in the database 330. Next, the model operating processor 323 may perform collected data parsing in step 615 and data smoothing preprocessing in step 617. After the data smoothing preprocessing operation, the model operating processor 323 may obtain smoothing period data in step 619. Next, the model operating processor 323 may input the smoothing period data into the statistical-based period filtering and AI model in step 621 and obtain recovery data in step 623. In step 625, the model operating processor 323 may perform a mean absolute error (MAE) calculation using the smoothing period data and the recovery data. In step 627, the model operating processor 323 may check whether the calculated MAE value is greater than a predetermined recovery threshold. If the MAE value is less than the recovery threshold, the model operating processor 323 may perform detection error processing (False) and notify it. Meanwhile, the model operating processor 323 is at least one computing resource for anomaly period detection and may be a hardware or software component forming at least a part of the server device 320. Alternatively, the model operating processor 323 may include a separate computing resource (e.g., a computing resource including at least a part of hardware and software) that is connected to the server device 320 functionally or based on a communication channel and is capable of supporting model operation related to the anomaly detection function.

If the MAE value is greater than the recovery threshold, the server device 320 may store the detection result (e.g., store it in the database 330) in step 629. Next, in step 631, the server device 320 may perform an alarm system execution. For example, the server device 320 may create an alarm message and transmit it to the alarm device 310.

In relation to the above-described execution timing of the anomaly period detection model, the server device 320 may obtain a unique ID of the sensor 200 that requested data storage before the execution of the model, retrieve a model in which activation of a target sensor corresponding to the sensor 200 and learning have been completed, retrieve and merge recent data in an amount (depending on the hyper-parameter settings) capable of additionally performing smoothing preprocessing on previous data and newly accumulated data, and perform smoothing preprocessing. In relation to operating the alarm system, the server device 320 may process an alarm by calling the alarm system as an internal or external OpenAPI and may terminate the detection process if there is no separate alarm system execution. Since the process of parsing the collected data in the model operating processor 323 is not limited to newly accumulated data and has the characteristic of being able to be executed at any time, the Swim-Lane of the sensor 200 may add a Swim-Lane directly executed by the administrator 11 or a Swim-Lane periodically automatically executed by the scheduler (S1). The Swim-Lane directly executed by the administrator 11 requires a collected data range, and the Swim-Lane periodically automatically executed by the scheduler (S1) is performed based on the data accumulated from the time before the scheduler cycle based on the execution time.

FIG. 7 is a diagram showing an example of a connection point of a detection process according to an embodiment of the present disclosure.

Referring to FIGS. 1 to 7, in relation to the detection process connection point, the administrator 11 or the scheduler (S1) may request the execution of an anomaly detection model (or a learning-completed statistical-based period filtering and AI model) in step 701. In this case, the administrator 11 may create a message requesting the operation of the anomaly detection model using the user terminal 100 and transmit the message to the server device 320. Alternatively, the scheduler (S1) may create a message requesting the execution of the anomaly detection model when a predetermined period arrives and transmit the message to the server device 320.

In step 703, the server device 320 may receive the message requesting the execution of the anomaly detection model from the user terminal 100 of the administrator 11 or the scheduler (S1) and then transmit it to the model operating processor 323. Then, in step 705, the model operating processor 323 may perform the anomaly period detection process described above in FIG. 6 in response to the execution request of the anomaly detection model.

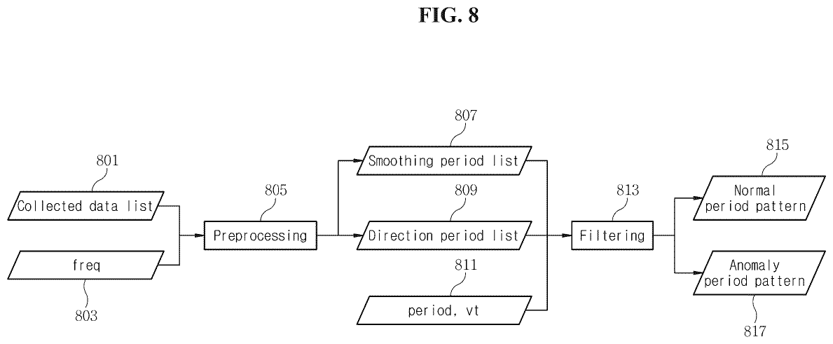

FIG. 8 is a diagram showing an example of a statistical-based period filtering method according to an embodiment of the present disclosure.

Referring to FIGS. 1 to 8, in the statistical-based period filtering method, the server device 320 (or the processor of the server device 320) may acquire a collected data list in step 801, acquire a frequency (freq) in step 803, and then perform a preprocessing process in step 805. Here, the steps 801 and 803 may be performed in parallel or independently.

When the preprocessing process is completed, the server device 320 may create a smoothing period list in step 807 and create a direction period list in step 809. Meanwhile, the server device 320 may collect information on period (or section) and reference value (vt) in step 811. Next, in step 813, the server device 320 may perform a filtering process, and based on the result of the filtering process, determine a normal period pattern in step 815 or determine an anomaly period pattern in step 817.

As described above, the statistical analysis period filtering method is composed of the preprocessing process for preprocessing data for smooth statistical analysis and the filtering process for labeling automation, and may include a step for outputting pattern data in the form of normal and anomaly periods separated as a final result.

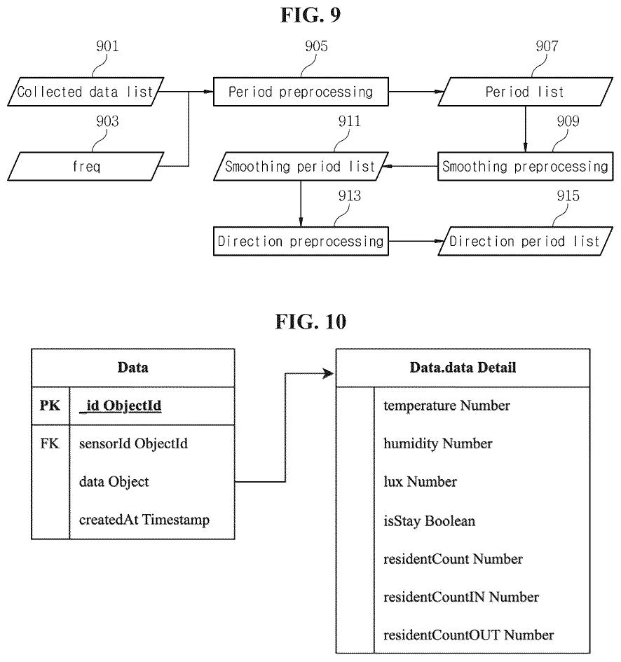

FIG. 9 is a diagram showing an example of a preprocessing process according to an embodiment of the present disclosure.

Referring to FIGS. 1 to 9, in the preprocessing process of the statistical-based period filtering method, the server device 320 (or at least one processor to which the server device 320 can be connected functionally or based on a communication channel) may acquire a collected data list in step 901 and acquire a frequency (freq) in step 903. Then, the server device 320 may perform period preprocessing in step 905 and thereby acquire a period list in step 907. Next, the server device 320 may perform smoothing preprocessing in step 909 and thereby acquire a smoothing period list in step 911. Next, the server device 320 may perform direction preprocessing in step 913 and thereby acquire a direction period list in step 915. In relation to the above-described operations, the server device 320 may include a preprocessing processor capable of performing a preprocessing process, and the preprocessing processor may include a data list collector, a period information collector, a period preprocessor, a smoothing preprocessor, and a direction preprocessor, which are configured at least in part by hardware or software.

As described above, the server device 320 may perform three preprocessing operations based on the collected data list and the hyper-parameter frequency (freq), and output the smoothing period list and the direction period list through the preprocessing operations.

FIG. 10 is a diagram showing an example of a period collection list of an IoT sensor according to an embodiment of the present disclosure.

Referring to FIGS. 1 to 10, the period collection list of the IoT sensor may include a collected data entity (Data) that records residential information data measured from the sensor 200 installed in a building, which may include, as main properties, sensorId ObjectId, data Object of object type, and createdAt Timestamp of timestamp type. Here, sensorId ObjectId corresponds to a sensor ID, and data Object records temperature (temperature Number), humidity (humidity Number), illuminance (Lux Number), occupancy (isStay Boolean), number of residents (resident Count Number), number of residents entering (residentCountIN Number), and number of residents leaving (residentCountOut Number) measured by the sensor 200. Also, createdAt Timestamp records the measurement time.

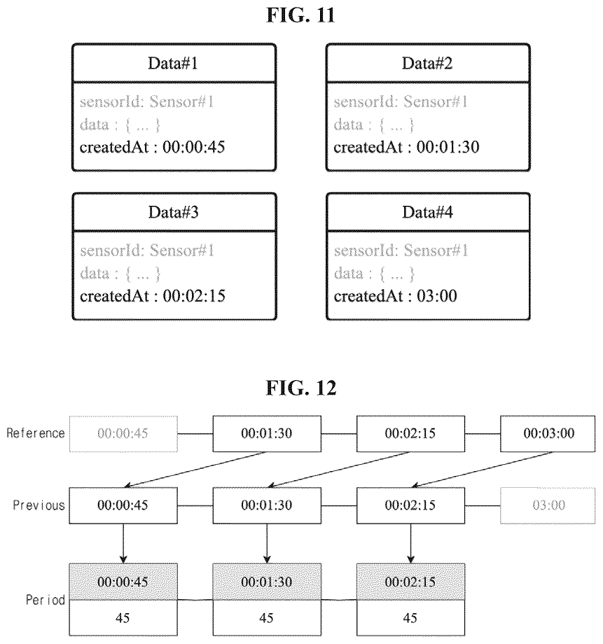

FIG. 11 is a diagram showing an example of a collected data storage object according to an embodiment of the present disclosure.

Referring to FIGS. 1 to 11, the collected data storage object may collectively have the form of time series data due to repeated measurement and storage request tasks of the IoT sensor 200 at regular intervals. Considering the time series data as a single collected data list, the server device 320 may acquire a collected time list data by parsing the createdAt property of each element.

FIG. 12 is a diagram showing an example of preprocessing of period of raw data according to an embodiment of the present disclosure.

Referring to FIGS. 1 to 12, when the server device 320 acquires the collected time list data as described above in FIG. 11, in relation to the period preprocessing operation, it may construct a reference time list composed of the second element to the last element in the collected time list data, and a previous time list composed of the first element to the element immediately before the last element. The server device 320 may acquire the period list data in seconds by obtaining the time error of each element of the data composed of the reference time list and the previous time list. Here, the index of the period list data has the value of the previous time as an index.

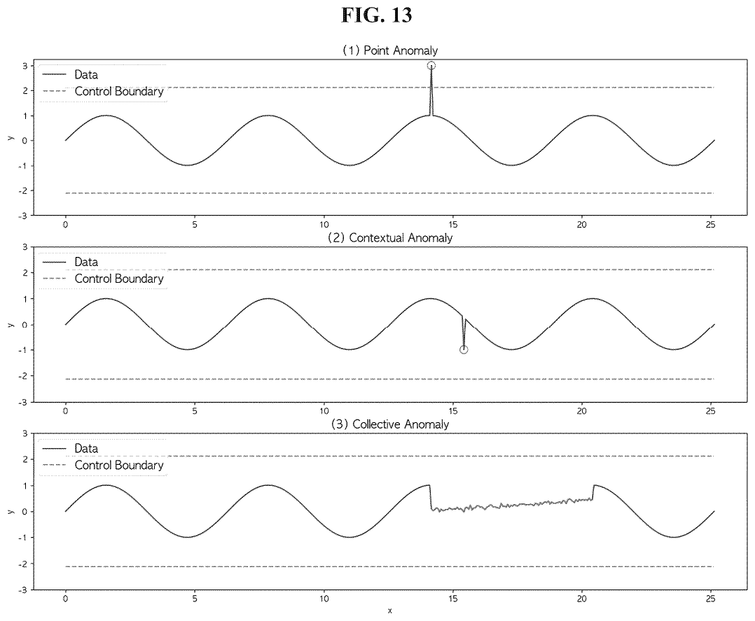

Meanwhile, when period list data is used, various noises or temporary errors may be included. Therefore, pattern detection for the period list data is required, and preprocessing for smoothing may be required to comprehensively check whether an anomaly occurs during the pattern detection process. In this regard, the server device 320 may apply a control boundary and perform smoothing on the calculated period pattern. This will be described with reference to FIGS. 13 to 22.

FIG. 13 is a diagram showing an example of anomaly phenomenon classification based on control boundary according to an embodiment of the present disclosure.

After the period list data described above in FIG. 12 is acquired, control boundaries may be set to perform preprocessing for smoothing the period list data. For example, the control boundaries may be set based on Equations 1 and 2 below.

$$UCL = Timeseries + k \times {σ}_{Timeseries} \qquad [ Equation 1 ]$$

$$LCL = Timeseries - k \times {σ}_{Timeseries} \qquad [ Equation 2 ]$$

In Equation 1, UCL denotes an upper control limit, and in Equation 2, LCL denotes a lower control limit. In Equations 1 and 2, Timeseries denotes an average of time series data list elements, and σ_{Timeseries} denotes a standard deviation value for which a hyper-parameter k is set. As described above, the control boundaries (e.g., the upper control limit and the lower control limit) distinguishes variation due to two causes, namely, coincidence and abnormal cause, and may be set using the average of time series data list elements and the standard deviation for which a hyper-parameter k (e.g., k=3) is set.

Referring to FIGS. 1 to 13, anomalies that can be explained through control boundaries may be divided into a point anomaly, a contextual anomaly, and a collective anomaly. The point anomaly may include a data point or sequence that suddenly exceeds a standard corresponding to the upper or lower limit defined by the control boundary. The contextual anomaly may include a data point or sequences that suddenly occurs within a standard (e.g., within the upper and lower limits of the control boundary). The collective anomaly may include a data set of points and contextual anomalies that have persistence.

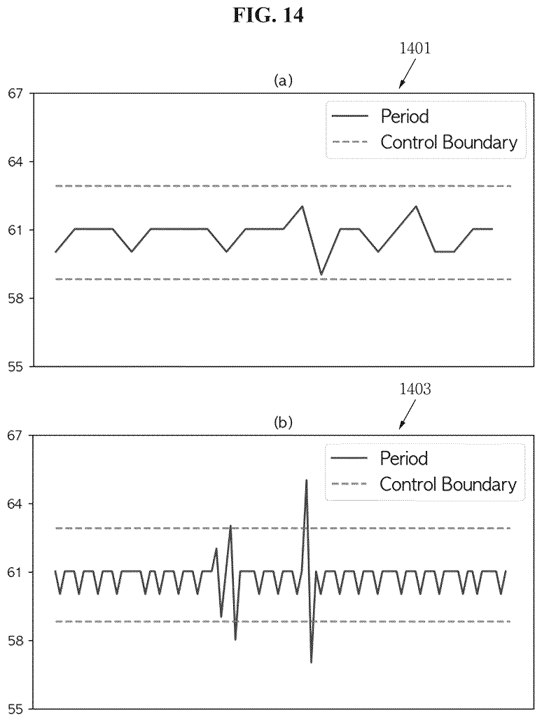

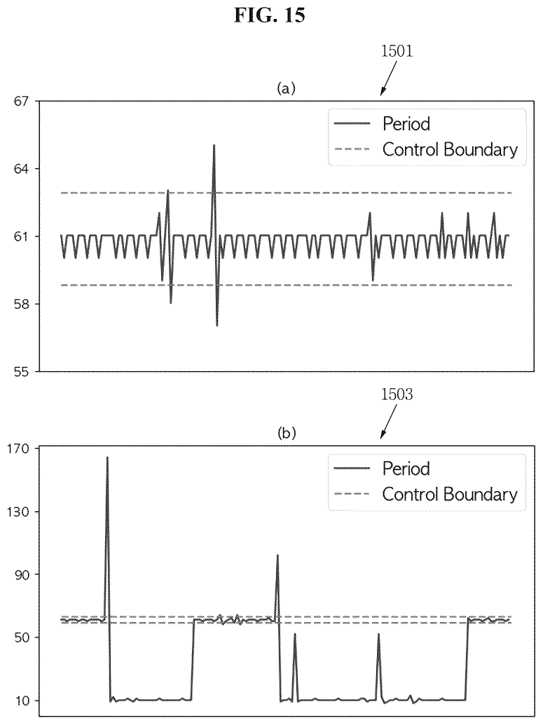

FIG. 14 is a diagram showing an example of period data visualization according to period data smoothing, and FIG. 15 is a diagram showing another example of period data visualization according to period data smoothing.

Referring to FIGS. 1 to 14, a general period pattern of the IoT sensor 200 does not have a completely constant form due to constraints of hardware and network environment, and has a form that includes persistent contextual anomalies within the control boundary as in a state 1401 or a form that includes a point anomaly in addition to the persistent contextual anomalies as in a state 1403.

Referring to FIGS. 1 to 15, it can be seen that the period pattern of the IoT sensor 200 generally has a collective anomaly. A state 1501 is an extension of the time of the point anomaly in the state 1403 described above, and may be interpreted as a form of temporary error recovery after the point anomaly occurs. Meanwhile, the period pattern of a state 1503 may be interpreted as a collective anomaly of persistent point anomalies occurring, and this case may clearly correspond to an anomaly period pattern. As described above, since irregular period patterns may include a large number of noises and temporary errors, classifications in which the distinction between normal and anomaly is unclear may occur.

Accordingly, in preprocessing by the server device 320, data smoothing may be performed to reduce the confusion of period data.

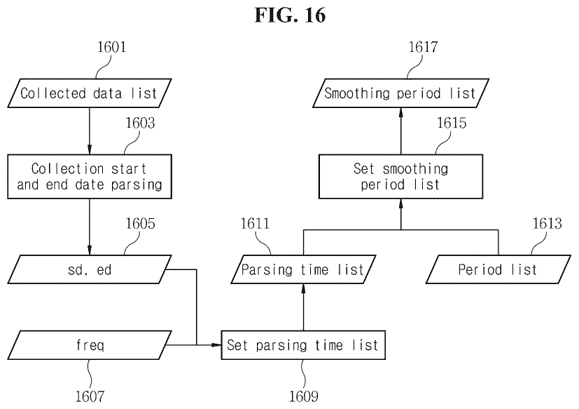

FIG. 16 is a diagram showing an example of a smoothing preprocessing method according to an embodiment of the present disclosure.

Referring to FIGS. 1 to 16, in relation to the smoothing preprocessing method, the server device 320 may acquire a collected data list in step 1601. For example, the collected data list may be acquired by retrieving information stored in the database 330. The server device 320 may parse collection start and end date in step 1603 and thereby extract a collection start date (sd) and a collection end date (ed) in step 1605. On the other hand, the server device 320 may acquire frequency (freq) information in step 1607, and the frequency (freq) information may be input from the administrator 11 or by the scheduler (S1).

The server device 320 may set a parsing time list in step 1609 and thereby acquire the parsing time list in step 1611. In addition, the server device 320 may acquire a period list in step 1613 (e.g., acquire the period list according to the method described above in FIG. 12). Then, the server device 320 may set a smoothing period list by using the parsing time list and the period list in step 1615 and thereby acquire the smoothing period list in step 1617.

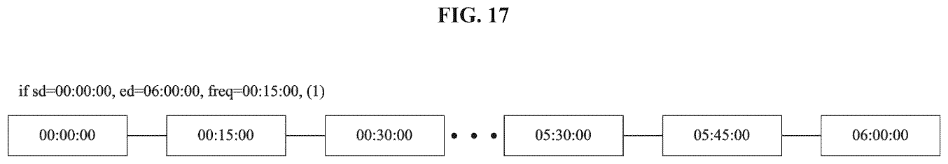

FIG. 17 is a diagram showing an example of setting a parsing time list according to an embodiment of the present disclosure.

Referring to FIGS. 1 to 17, the server device 320 may set the parsing time list by configuring a time range from the collection start date (sd) to the collection end date (ed) at an interval of the frequency (freq). FIG. 17 shows an example in which the start date is set to 00:00:00, the end date is set to 06:00:00, and the frequency (freq) is set to 15 minutes. According to this setting of the parsing time list, the server device 320 may produce a parsing time list setting at a 15-minute interval. The frequency (freq) may be adjusted by the administrator 11 or the scheduler (S1).

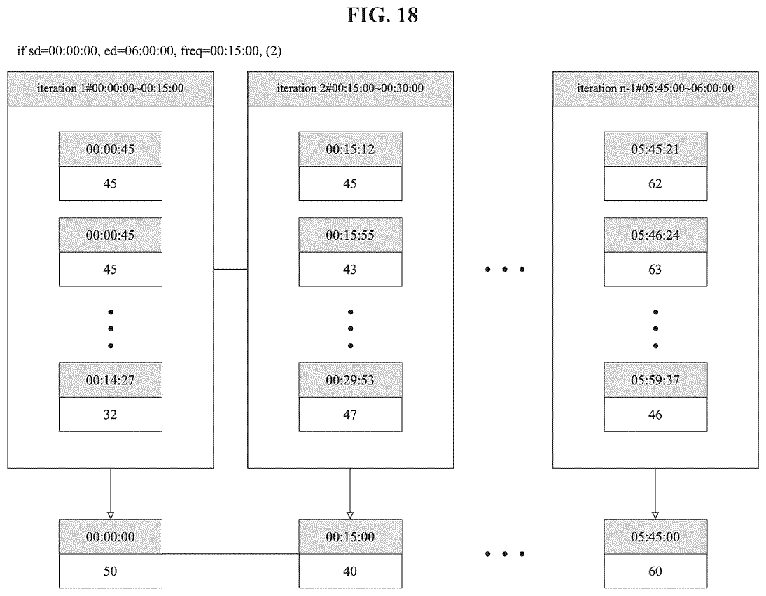

FIG. 18 is a diagram showing an example of setting a smoothing period list according to an embodiment of the present disclosure.

Referring to FIGS. 1 to 18, the server device 320 may iterate until the last element of the parsing time list and set the smoothing period list as values processed by approximating the average value of a period data set including a time interval element between the index of each iteration and the next index by 10 units. The parsing time list setting applied to the smoothing period list setting may include the parsing time list setting described above in FIG. 17.

Referring to FIG. 18, for example, the server device 320 may produce a value of 50 by approximating the data average value by 10 units in the first iteration (iteration 1 #) for the first 15 minutes, produce a value of 40 by approximating the data average value by 10 units in the second iteration (iteration 2 #) for the next 15 minutes, and produce a value of 60 by approximating the data average value by 10 units in the n−1th iteration (iteration n−1 #) for the last 15 minutes.

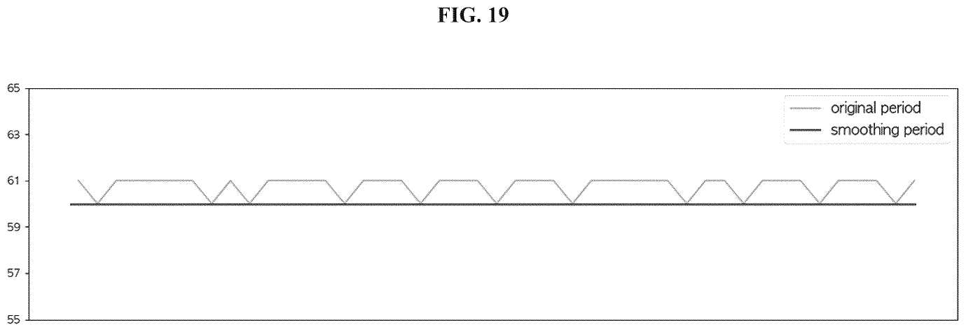

FIG. 19 is a diagram showing an example of comparing original period data and smoothing period data according to an embodiment of the present disclosure.

Referring to FIGS. 1 to 19, the smoothing period data shown in FIG. 19 represents an example of a normal period pattern. As shown, the normal period data that has undergone data smoothing exhibits a period pattern of a constant value by alleviating the irregularity of original period data. In the illustrated example, since the standard deviation is 0, the control boundary may be the same as the average value. A situation where the standard deviation is 0 can provide a perspective capable of immediately interpreting the change in the period as a point anomaly or a collective anomaly.

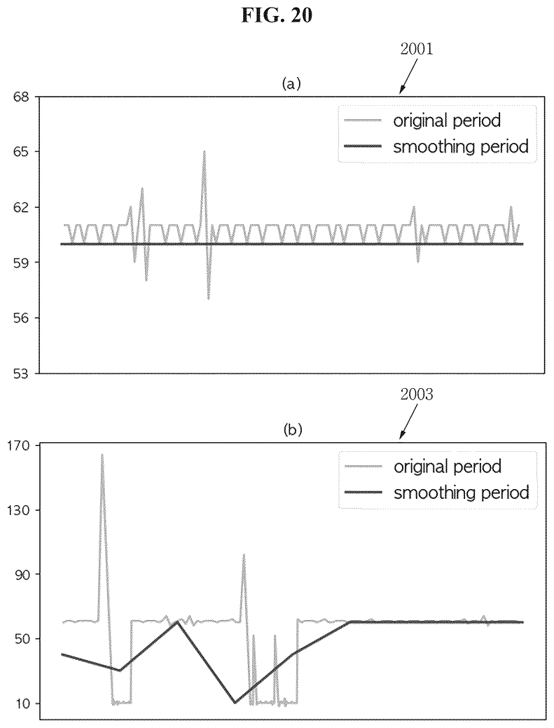

FIG. 20 is a diagram showing another example of comparing original period data and smoothing period data according to an embodiment of the present disclosure.

Referring to FIGS. 1 to 20, FIG. 20 shows an example of an anomaly period pattern. In FIG. 20, a state 2001 shows an anomaly period pattern corresponding to the recovery type of the point anomaly described in the state 1501 of FIG. 15, and a state 2003 shows an anomaly period pattern corresponding to the persistence type in the state 1503. In the case of the recovery type, the severity of the point anomaly is low, showing a pattern similar to a normal period, and the persistence type shows a pattern including continuous point anomalies.

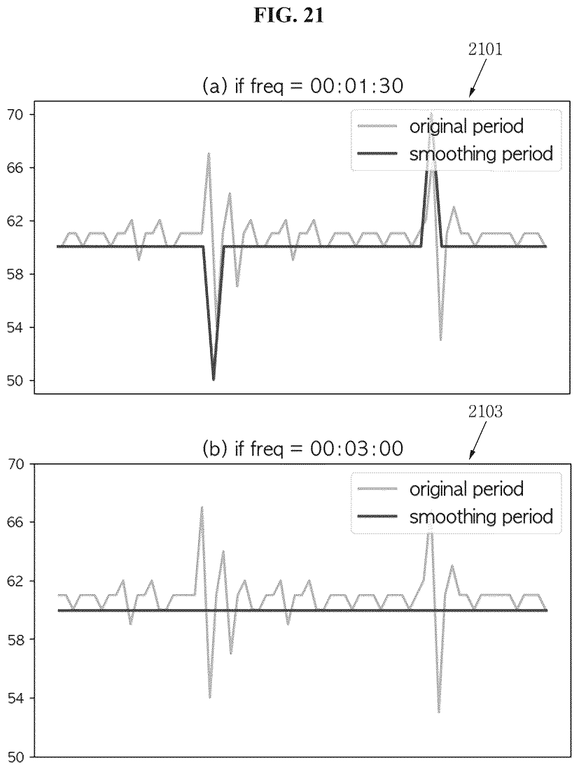

FIG. 21 is a diagram showing an example of adjusting the intensity of smoothing preprocessing according to an embodiment of the present disclosure.

Referring to FIGS. 1 to 21, the intensity of smoothing preprocessing may vary depending on the density setting of the frequency (freq). For example, comparing the original period data and the smoothing period data between a state 2101 in which the frequency (or frequency variable) setting is 1 minute and 30 seconds and a state 2103 in which the frequency setting is 3 minutes, it can be seen that the anomaly period pattern of the state 2101 has a larger size of anomaly occurrence size than that of the state 2103. The derivation of the optimal value for the setting (or density setting) of the frequency (or frequency variable) may be performed empirically or statistically.

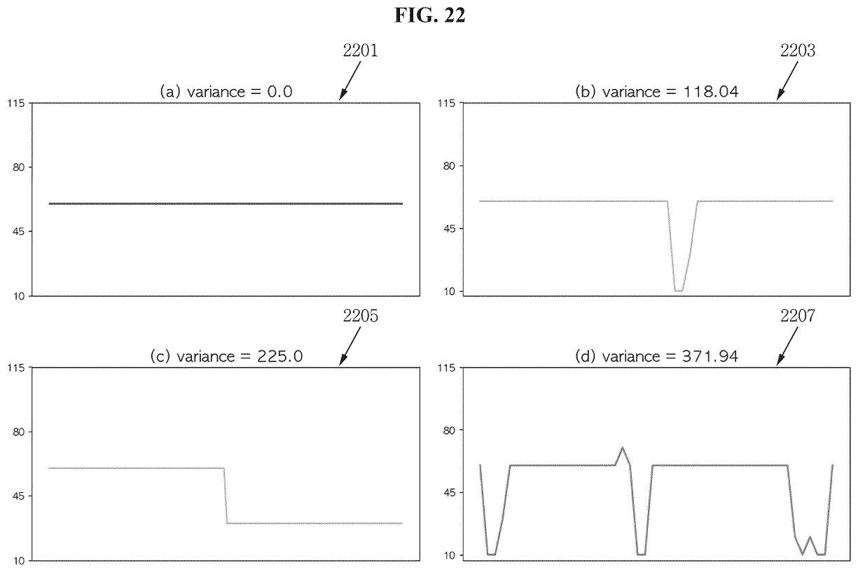

FIG. 22 is a diagram showing an example of an average variance value of point data by smoothing period pattern according to an embodiment of the present disclosure.

Referring to FIGS. 1 to 22, FIG. 22 shows data obtained by observing changes in the smoothing period pattern according to a variance size. For example, a state 2201 shows a smoothing period pattern corresponding to a normal state with a variance value of 0, and a state 2203 shows a smoothing period pattern having a temporary anomaly with a variance value of 118.04. In addition, a state 2205 shows a smoothing period pattern having a first type persistent anomaly with a variance value of 225.0, and a state 2207 shows a smoothing period pattern having a second type persistent anomaly with a variance value of 371.94. The states 2201 and 2203 may be classified as normal, and the state 2207 may be classified as anomaly. However, the state 2205 may be classified as normal, which is due to the form of the variance value that cannot be generalized to a specific range. As such, there may be difficulty in selecting an appropriate threshold for the variance values, and in this case as in the state 2205, a detection error may occur in an exceptional situation, such as a stair shape, due to a period modification event of the administrator 11.

To cope with the exceptional situation described above, the server device 320 may perform preprocessing on the directionality of the period data. That is, the server device 320 may detect an anomaly period pattern by considering the directionality of the time series data.

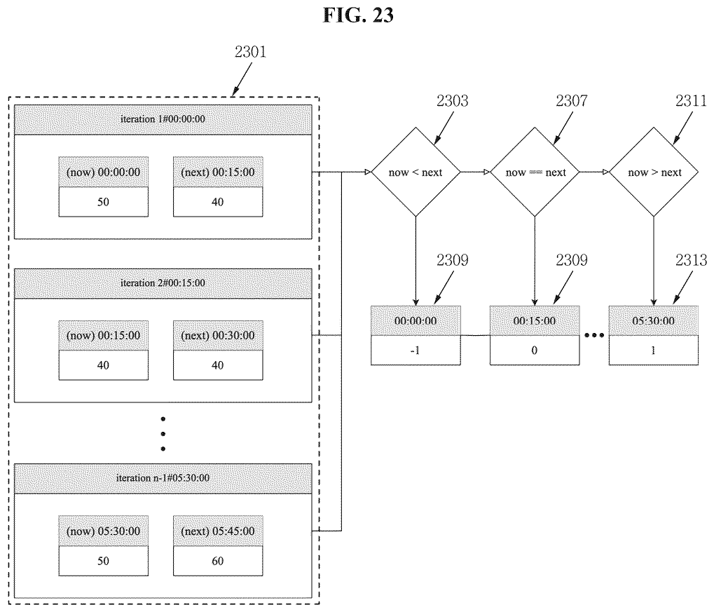

FIG. 23 is a diagram showing an example of data related to direction preprocessing according to an embodiment of the present disclosure.

Referring to FIGS. 1 to 23, in relation to direction preprocessing, the server device 320 may track changes in the respective iteration values for the smoothing period list described in FIG. 18. In relation to this, the server device 320 may obtain a list 2301 to compare the current smoothing period value and the next smoothing period value in each iteration, and check in step 2303 whether the current value (now) is smaller than the next value (next). If the current value is smaller than the next value, the server device 320 may assign −1 as the result value for the direction preprocessing of the corresponding iteration in step 2305.

If the current value is not smaller than the next value in the step 2303, the server device 320 may check in step 2307 whether the current value is equal to the next value. If the current value is equal to the next value, the server device 320 may assign 0 as the result value for the direction preprocessing of the corresponding iteration in step 2709.

If the current value is not equal to the next value in the step 2307, the server device 320 may check in step 2311 whether the current value is greater than the next value. If the current value is greater than the next value, the server device 320 may assign 1 as the result value for the direction preprocessing of the corresponding iteration in step 2713.

As described above, using the smoothing period list, the server device 320 may extract the directional characteristics of the period. For example, the server device 320 may record the element-by-element period change classification as −1 if the next period value decreases in each iteration, 0 if maintained, and 1 if increases while iterating up to the last element of the smoothing period list, thereby configuring the direction period data.

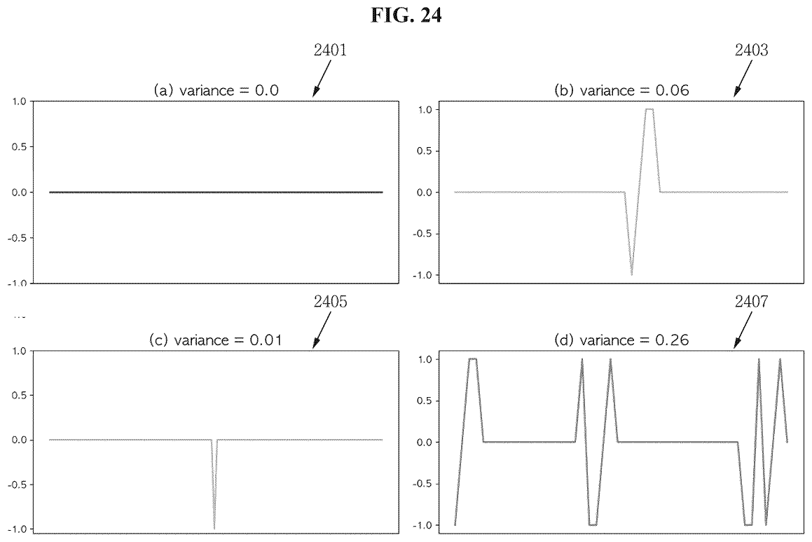

FIG. 24 is a diagram showing an example of an average variance value of point data by direction period pattern according to an embodiment of the present disclosure.

Referring to FIGS. 1 to 24, FIG. 24 shows the direction period data obtained by applying the direction preprocessing to the smoothing period data shown in FIG. 22. Specifically, a state 2401 indicates that a normal pattern is maintained with smoothing, and a state 2403 indicates a temporary anomaly pattern. In addition, a state 2405 indicates that the stair pattern shown in the state 2205 of FIG. 22 has changed to a pattern including a single point anomaly, and a state 2407 indicates a collective anomaly pattern and allows anomaly detection because an irregular shape is maintained similarly to the state 2207 of FIG. 22. The direction periodic pattern shown in FIG. 24 is composed of −1, 0, and 1 as described above and has the characteristics of categorical data (e.g., the variance value ranges between 0 and 1, such as 0 for the state 2401, 0.06 for the state 2403, 0.01 for the state 2405, and 0.26 for the state 2407). Therefore, compared to the unclear smoothing periodic variance value described in FIG. 22, in the case of the direction period pattern shown in FIG. 24, the severity of the pattern change may be confirmed relatively clearly for normal and anomaly, and the server device 320 may support threshold setting for changes in such direction period patterns.

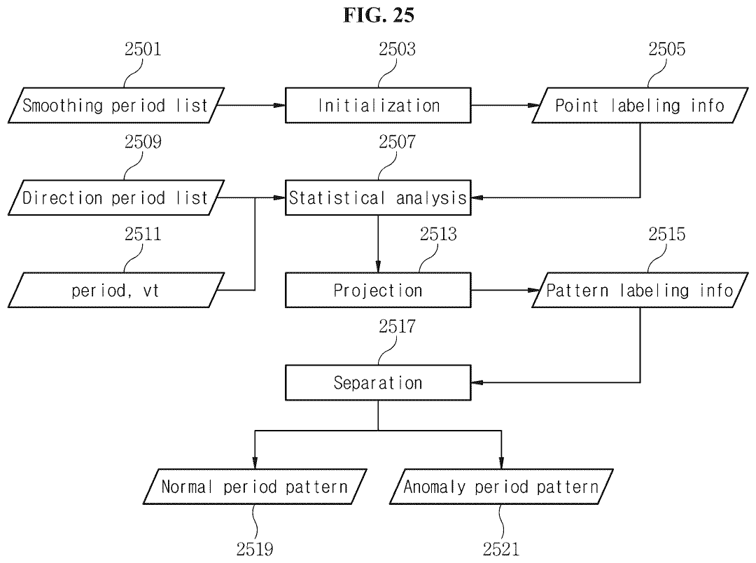

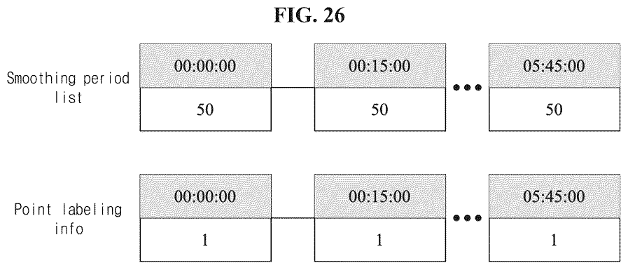

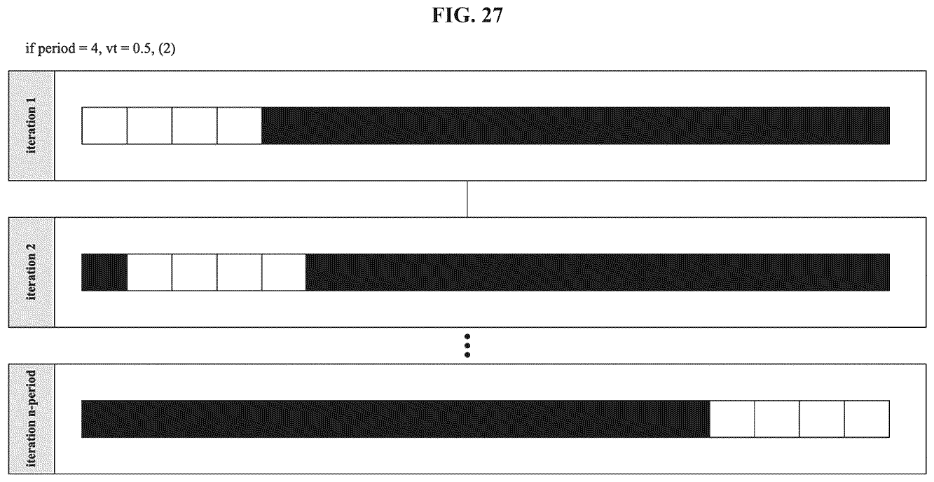

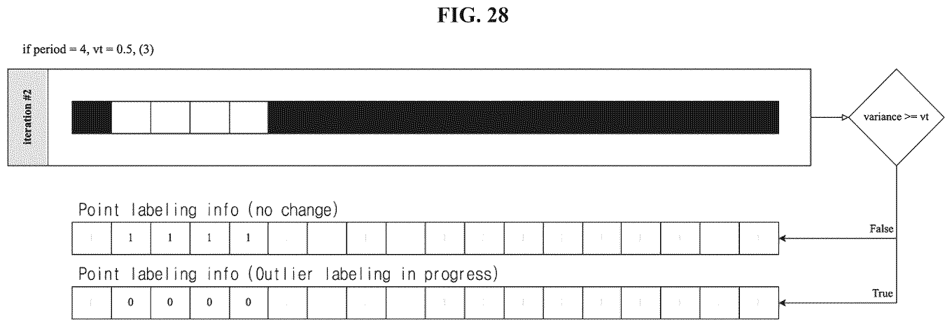

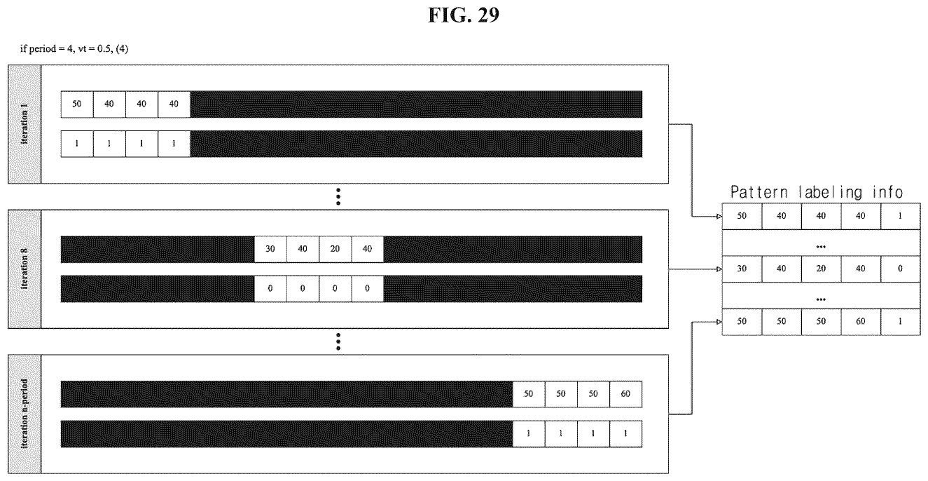

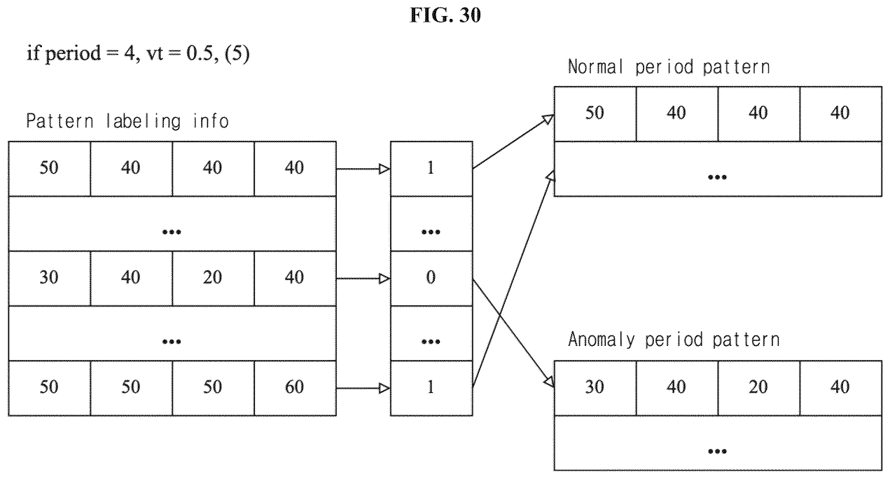

FIG. 25 is a diagram showing an example of a filtering process according to an embodiment of the present disclosure. FIG. 26 is a diagram showing an example of initializing a labeling information list according to an embodiment of the present disclosure. FIG. 27 is a diagram showing an example of applying a sliding window according to an embodiment of the present disclosure. FIG. 28 is a diagram showing an example of applying point labeling according to an embodiment of the present disclosure. FIG. 29 is a diagram showing an example of a projection step according to an embodiment of the present disclosure. FIG. 30 is a diagram showing an example of a separation step according to an embodiment of the present disclosure.

First, referring to FIGS. 1 to 25, in the filtering process (or filtering method) of the statistical-based period filtering method, the server device 320 may acquire a smoothing period list in step 2501, perform an initialization process in step 2503, and acquire point labeling information in step 2505. The smoothing period list may be created by, as described in FIG. 16, parsing the collection start and end dates in the collected data list, applying the frequency value, acquiring the parsing time list, and merging it with the period list. The initialization may include a process of defining a labeling information list having the same length as the smoothing period list and entering a value for each element as a designated value (e.g., 1 meaning normal). Referring to FIGS. 1 to 26, the server device 320 may perform an operation of initializing the point labeling information list by identifying the value of the smoothing period list and, if the identified value has a specific value (e.g., a predefined reference value vt corresponding to a variance value threshold variable), assigning 1.

In step 2507, the server device 320 may perform statistical analysis. In this regard, the server device 320 may acquire a direction period list in step 2509 and also acquire a period value and a reference value (vt) in step 2511. In the statistical analysis, the server device 320 may perform analysis by applying the direction period list, the period value, and the reference value. In addition, the server device 320 may apply a sliding window to the direction period list, measure a variance value within an individual window space, and compare it with the reference value (vt) defined as a threshold variable. If the comparison result has a value of an anomaly pattern, the server device 320 may perform labeling by modifying the value of the point labeling information list element of the same index as the individual window space where the measurement was performed to 0 and thereby indicating that it is a point anomaly belonging to the anomaly pattern. Referring to FIGS. 1 to 27, the server device 320 may apply a sliding window to each iteration based on a condition that the period is 4 and the reference value (vt) is 0.5 for the smoothing period list. For example, the server device 320 may sequentially apply a 4-space sliding window to the first iteration, to the second iteration, and so on, to the nth iteration. Referring to FIGS. 1 to 28, while applying a sliding window corresponding to a predetermined period (e.g., period 4) to a specific iteration, the server device 320 may check whether the average of the variance values included in the corresponding sliding window is greater than or equal to a predetermined reference value (vt). The server device 320 may maintain a situation in which point labeling information 1 is assigned if the average of the variance values of the list included in the sliding window is not greater than the reference value (vt), and may assign 0 to proceed with point anomaly labeling if the average of the variance values of the list included in the sliding window is greater than or equal to the reference value (vt).

The server device 320 may perform a projection operation in step 2513 and produce pattern labeling information in step 2515. The projection operation may include an operation of applying the sliding window for both the smoothing period list and the point anomaly labeling list and defining labeling information. For example, in the projection operation, the server device 320 may create a pattern by adding 0 to the last element when the point anomaly labeling information data for the smoothing period pattern in an individual window space is entirely 0, and adding 1 otherwise, and then define a pattern labeling information matrix by integrating whether the created pattern is an anomaly pattern. Referring to FIGS. 1 to 29, the server device 320 may apply the sliding window for both the smoothing period list and the point labeling information list or the point anomaly labeling information list and enter 1 or 0 into the last element for the values of the corresponding labeling information list of each iteration to support classification between normal and anomaly.

Next, in step 2517, the server device 320 may perform a separation operation based on the characteristics of the pattern labeling information matrix to classify the corresponding pattern labeling information into a normal period pattern as in step 2519 or an anomaly period pattern as in step 2521. In the separation operation, the server device 320 may identify the last element of the pattern labeling information matrix to check whether the corresponding pattern is anomaly, and thereby perform an operation to separate the corresponding pattern into the normal period pattern and the anomaly period pattern. In relation to this, referring to FIGS. 1 to 30, the server device 320 may identify the last element of each pattern labeling information, and classify it into the normal period pattern if the last element is 1, or classify it into the anomaly period pattern if the last element is 0.

As described above, the server device 320, in relation to the labeling process for the smoothing period list, may receive the smoothing period list and the direction period list, which are main output data of the preceding preprocessing process, receive the window size variable (e.g., period) and the variance threshold variable (e.g., reference value vt) for sliding window progress, and perform initialization, statistical analysis, projection, and separation, thereby outputting either a normal period pattern or an anomaly period pattern.

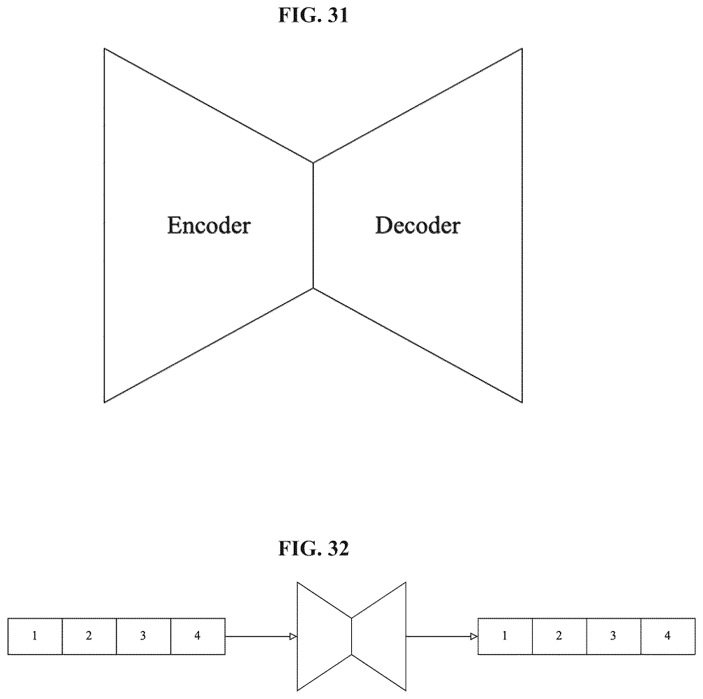

FIG. 31 is a diagram showing an example of an AutoEncoder applied to an anomaly period detection model according to an embodiment of the present disclosure. FIG. 32 is a diagram showing an example of input/output of an AutoEncoder according to an embodiment of the present disclosure.

Referring to FIGS. 1 to 31, the AutoEncoder is one of the unsupervised learning models that utilize neural network technology, and the neural network may be composed of Encoder and Decoder. The AutoEncoder model is trained in a manner of predicting an output value from an input value.

Referring to FIGS. 1 to 32, when a list of 1, 2, 3, and 4 elements is input as input values, the AutoEncoder model may be configured to output a list of 1, 2, 3, and 4 elements. The AutoEncoder model with such a neural network structure supports learning a method to restore the input value back to its original form, and since the receptive area of the neural network has a characteristic specialized for restoring input value features, it has a characteristic that when data with low similarity to the input value is input, the restoration does not proceed smoothly. By utilizing this aspect of the AutoEncoder in the field of anomaly detection, the restoration threshold for the learning-completed model is set in advance, and then normality and anomaly are determined through the error between the input and restoration data.

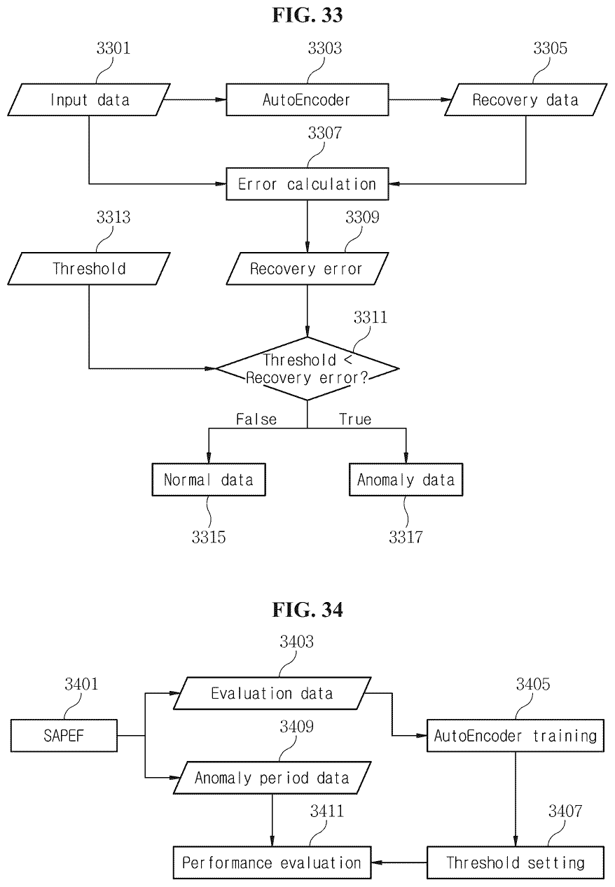

FIG. 33 is a diagram showing an example of an anomaly period detection method using an AutoEncoder with learning completed according to an embodiment of the present disclosure.

Referring to FIGS. 1 to 33, a computing device (e.g., the server device 320) may acquire input data (e.g., the period list, the smoothing period list, and the pattern labeling information) in step 3301, and provide it as an input to the AutoEncoder model in step 3303. The AutoEncoder model may produce recovery data for the input data in step 3305. The server device 320 may perform error calculation for the input data and the recovery data in step 3307 and produce a recovery error value in step 3309 based on the error calculation.

The server device 320 may check in step 3311 whether the recovery error value is greater than a predetermined threshold value. Here, the server device 320 may retrieve the threshold value from the database 330 or receive it as input from the administrator 11 in step 3313. If the recovery error value is not greater than the threshold value, the input data may be determined as normal data in step 3315, and if the recovery error value greater than the threshold value, the input data may be determined as anomaly data in step 3317.

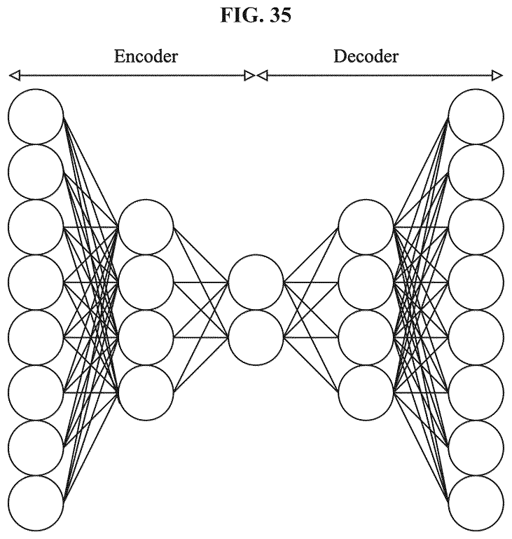

FIG. 34 is a diagram showing an example of a method for connecting a statistical-based period filtering model and an AutoEncoder model according to an embodiment of the present disclosure.

Referring to FIGS. 1 to 34, in step 3401, the server device 320 may perform a separation operation on the pattern labeling information list of the statistical-based period filtering model through the method described in FIGS. 8 to 30 above. If the server device 320 acquires a normal period pattern in step 3403, it may perform AutoEncoder training based on this in step 3405. Through the AutoEncoder training, the server device 320 may perform threshold setting in step 3407.

On the other hand, if an anomaly period pattern is obtained in step 3409 through the separation operation of the pattern labeling information list of the statistical-based period filtering model, the server device 320 may perform a performance evaluation on this in step 3411. In the performance evaluation process, the server device 320 may perform the performance evaluation based on the threshold setting value obtained in the step 3407.

The above-described statistical-based period filtering model (SAPEF) has a limitation that it is not suitable for the operational environment because it is a statistical model and has difficulty in deeply adapting to the diversity of time series data. In order to overcome the limitation of this unsupervised learning model, the labeling automation described above through FIGS. 25 to 30 is performed, and matrix data of normal period patterns and anomaly period patterns, which are the final output values of the statistical-based period filtering model, are utilized for AutoEncoder training, threshold setting, and evaluation, thereby overcoming the limitation of feature extraction of the statistical model.

FIG. 35 is a diagram showing an example of a neural network configuration of an AutoEncoder when a period value is 8 according to an embodiment of the present disclosure.

Referring to FIG. 35, the AutoEncoder may have a neural network structure in which eight input nodes are arranged in an input section (i.e., Encoder), and the eight input nodes are compressed into four intermediate layers and then compressed again into two intermediate layers. On the other hand, the AutoEncoder may include an output section (i.e., Decoder) in which two intermediate layers are expanded to four intermediate layers and then expanded to eight output nodes. FIG. 35 shows a case in which the period value is 8. If the period value is 4, the AutoEncoder (or AutoEncdoer model or AI model) may be configured with a neural network that includes four nodes in each of input and output sections.

The size of the period pattern data, which is the final output value of the statistical-based period filtering model, has a size of a hyper-parameter, period. Considering such fluidity, the AutoEncoder model configured with a neural network in which the dimension of input data is reduced by half in the Encoder section and is expanded twice in the Decoder section may be used in the statistical-based period filtering AI model. In the above model, all layers use fully connected layers.

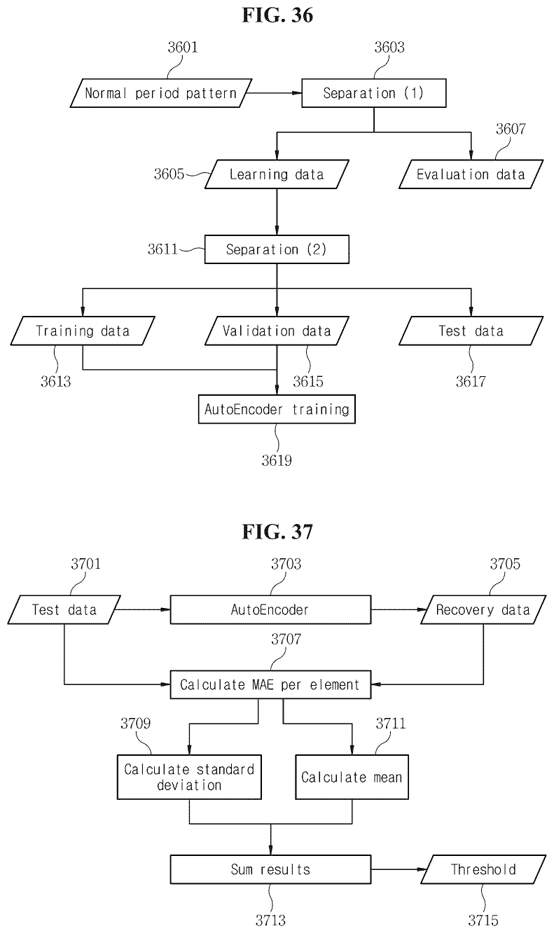

FIG. 36 is a diagram showing an example of a data separation process for AutoEncoder learning according to an embodiment of the present disclosure.

Referring to FIGS. 1 to 36, the server device 320 may acquire a normal period pattern in step 3601 and perform a first separation operation in step 3603. The normal period pattern may be acquired through a process of acquiring the normal period pattern as output data among the final output values of the statistical-based period filtering model described above. Through the first separation operation, the server device 320 may classify the normal period patterns into learning data in step 305 and evaluation data in step 3607.

In step 3611, the server device 320 may perform a second separation operation on the learning data. Through the second separation operation, the server device 320 may classify the learning data into training data in step 3613, validation data in step 3615, and test data in step 3617.

Next, in step 3619, the server device 320 may perform AutoEncoder training based on the training data and the validation data.

As described above, the server device 320 may separate the learning data and the evaluation data for AutoEncoder learning and threshold setting, separate the learning data into the training data, the validation data, and the test data, and train the AutoEncoder model using the training data and the validation data.

FIG. 37 is a diagram showing an example of a threshold setting method according to an embodiment of the present disclosure.

Referring to FIGS. 1 to 37, in relation to threshold setting, the server device 320 may acquire test data in step 3701 (e.g., through the two separation operations described in FIG. 36), transfer it to the input of the AutoEncoder in step 3703, and thereby acquire the corresponding recovery data in step 3705.

The server device 320 may calculate the mean absolute error (MAE) per element for the test data and the recovery data in step 3707. Through this MAE calculation, the server device 320 may perform a standard deviation calculation in step 3709 and an average calculation in step 3711. The server device 320 may sum up the calculation results for the standard deviation value and the average value in step 3713 and determine a threshold value based on this in step 3715.

As discussed, the server device 320 may input unused test data into a model whose learning has been completed, calculate a recovery pattern data set and a MAE per element, and sum up the average and standard deviation, thereby setting a threshold.

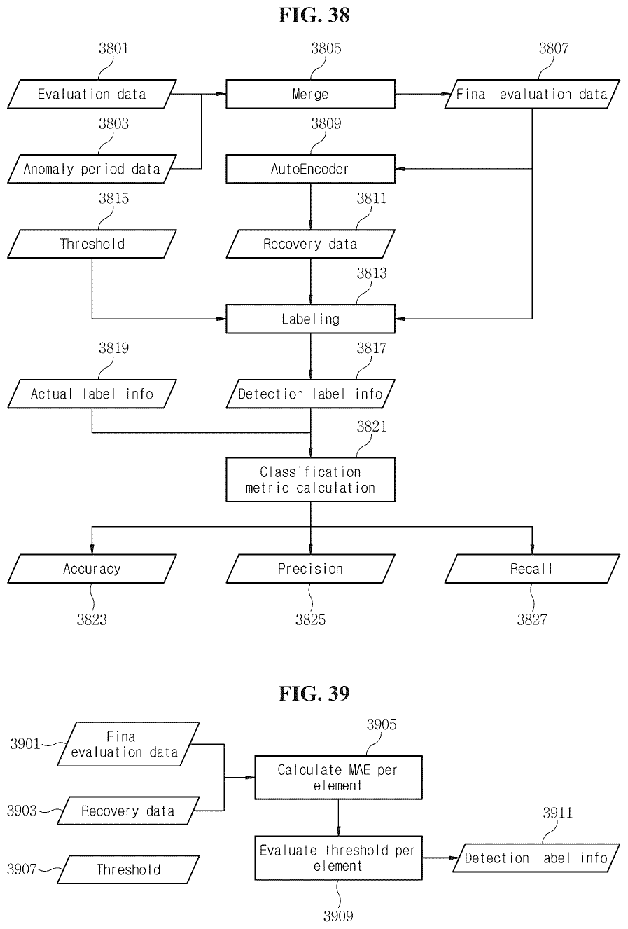

FIG. 38 is a diagram showing an example of a performance evaluation method according to an embodiment of the present disclosure. FIG. 39 is a diagram showing an example of a labeling method according to an embodiment of the present disclosure.

First, referring to FIGS. 1 to 38, in step 3801, the server device 320 may acquire the evaluation data through the first separation operation for the normal period pattern performed in FIG. 36 (or retrieve it from the database 330). In addition, in step 3803, the server device 320 may acquire anomaly period data (e.g., as the final output of the statistical-based period filtering model in FIG. 34) (or retrieve it from the database 330). The server device 320 may merge the evaluation data and the anomaly period data in step 3805 and produce the final evaluation data in step 3807.

The server device 320 may input the final evaluation data to the AutoEncoder in step 3809 and acquire recovery data as an output of the AutoEncoder in step 3811. In addition, the server device 320 may perform a labeling operation in step 3813. In relation to this, the server device 320 may acquire a threshold value in step 3815 and perform labeling using the final evaluation data of the step 3807 and the threshold value, thereby acquiring detection label information in step 3817. Referring to FIGS. 1 to 39 in relation to the labeling operation and the detection label information acquisition, the server device 320 may acquire final evaluation data in step 3901 (or as in the step 3807), acquire recovery data in step 3903 (or as in the step 3811), and then calculate a mean absolute error (MAE) per element on the final evaluation data and the recovery data in step 3905. Also, the server device 320 may acquire a threshold value in step 3907 (or as in the step 3815), evaluate a threshold per element based on the calculated MAE per element and threshold value in step 3909, and produce detection label information in step 3911 (or as in the step 3817).

In addition, the server device 320 may acquire actual label information in step 3819 and perform classification metric calculation based on the actual label information and the detection label information in step 3821, thereby producing accuracy as in step 3823, precision as in step 3825, and recall as in step 3827.

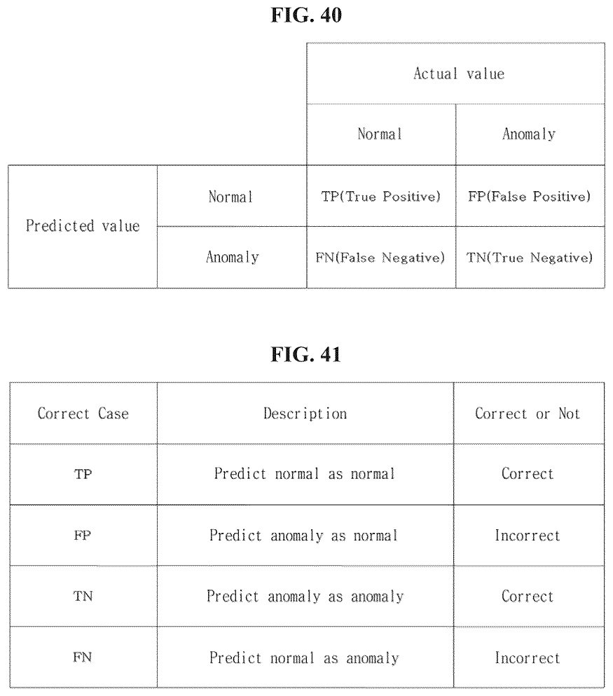

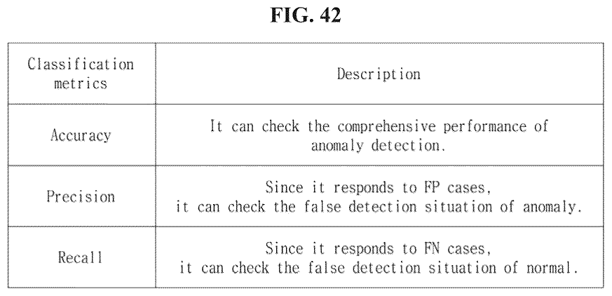

FIG. 40 is a diagram showing an example of interpretation by classification performance metrics cases in anomaly detection according to an embodiment of the present disclosure. FIG. 41 is a diagram showing another example of interpretation by classification performance metrics cases in anomaly detection according to an embodiment of the present disclosure. FIG. 42 is a diagram showing an example of interpretation by classification performance metrics in anomaly detection according to an embodiment of the present disclosure.

As shown in FIGS. 40 to 42, the server device 320 may provide classification metrics such as accuracy, precision, and recall by comparing the actual label information and the detection label information. The illustrated metrics are exemplified as being measured through four answer cases. Considering that the field of classification is anomaly detection, as shown in FIGS. 40 and 41, the server device 320 may present a case that an actual normal pattern is predicted as normal as a correct answer (TP), a case that an actual anomaly pattern is predicted as normal as an incorrect answer (FP), a case that an actual anomaly pattern is predicted as anomaly as a correct answer (TN), and a case that an actual normal pattern is predicted as anomaly as an incorrect answer (FN). Alternatively, in relation to the calculation of classification performance metrics, the server device 320 may present accuracy, precision, and recall as shown in FIG. 42, and the accuracy, precision, and recall may be defined by Equations 3 to 5, respectively.

$$Accuracy = \frac{T P + T N}{T P + T N + F P + T N} \qquad [ Equation 3 ]$$

$$Precision = \frac{T P}{T P + F P} \qquad [ Equation 4 ]$$

$$Recall = \frac{T P}{T P + F N} \qquad [ Equation 5 ]$$

In Equations 3 to 5, TP denotes true positive, TN denotes true negative, FP denotes false positive, and FN denotes false negative.

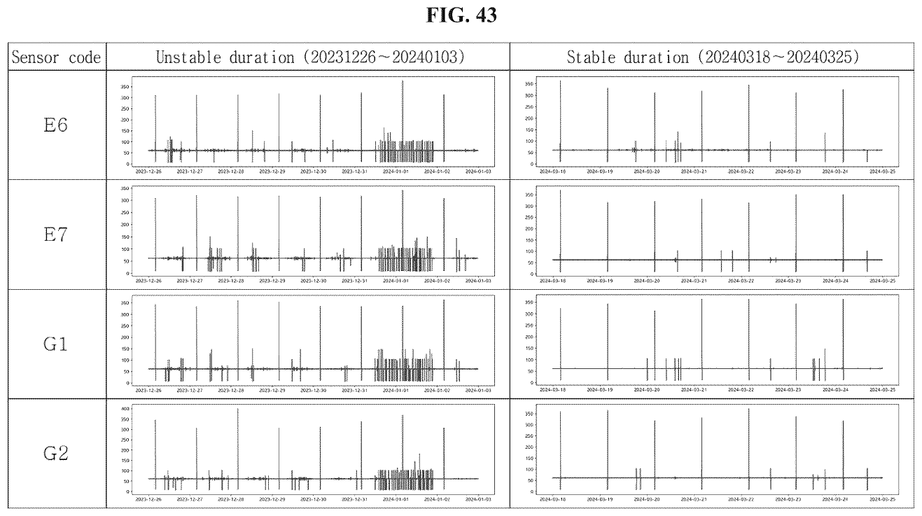

FIG. 43 is a diagram showing an example of an experimental environment related to an experiment and performance analysis based on residential information data using an anomaly period detection model according to an embodiment of the present disclosure.

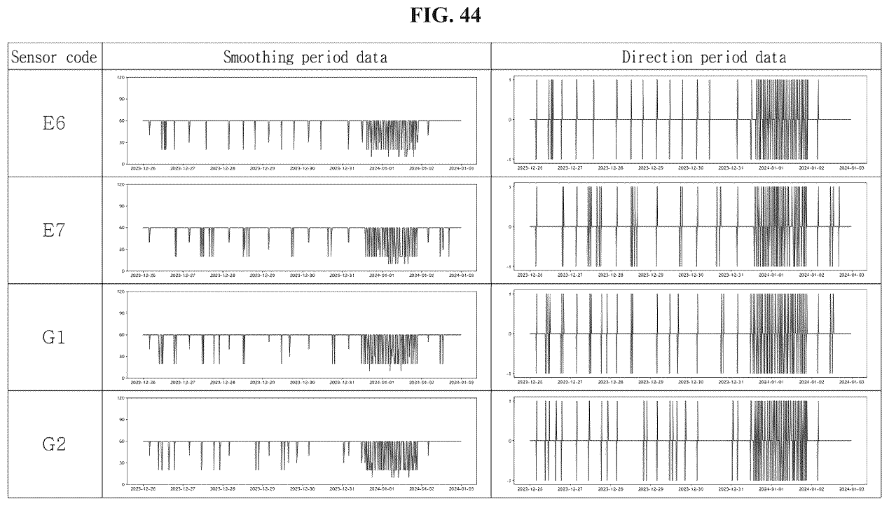

Referring to FIGS. 1 to 43, the anomaly period detection model is a statistical-based period filtering AI model described above and may be an example of an integrated form of a statistical-based period filtering model and an AI (e.g., AutoEncoder) model. The experimental environment of the anomaly period detection model is to use sensor data acquired from four sensors (E6, E7, G1, and G2) installed in a building and collecting residential information as inputs of the anomaly period detection model, derive classification metrics, check the accuracy and reliability through this, and thereby verify the operability. In an unstable duration (Dec. 26, 2023 to Jan. 3, 2024), it can be seen that the sensor communication is unstable and an anomaly period pattern is visible even to the naked eye. In a stable duration (Mar. 18, 2024 to Mar. 25, 2024), it can be seen that the sensor communication is stable and an anomaly period pattern appears with low severity. In the case of the environmental dataset experiment in the above unstable duration, the object of the statistical-based period filtering model was initialized by setting, as hyper-parameter information, the frequency variable (freq) to 00:15:00, the period (or sliding window size variable) to 16, and the threshold variable value (vt) or next value (next) to 0.5, and this setting was applied equally to all sensors (E6, E6, G1, and G2). Hereinafter, the operation results of the anomaly detection model in the unstable duration of the experimental environments described above will be described through FIGS. 44 to 54.

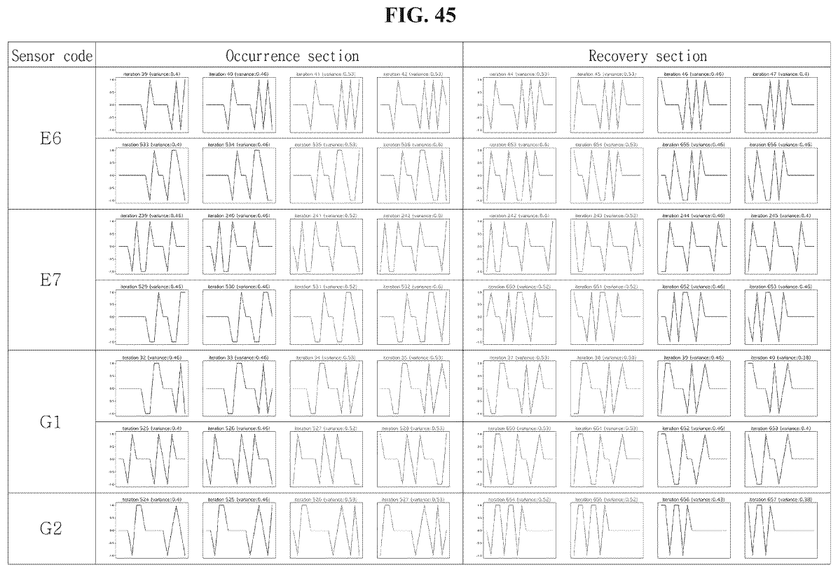

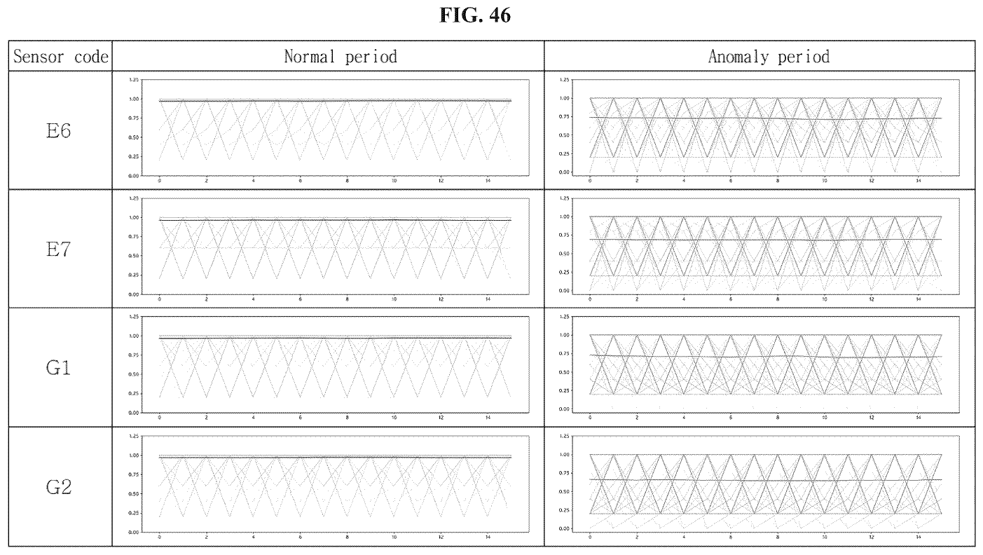

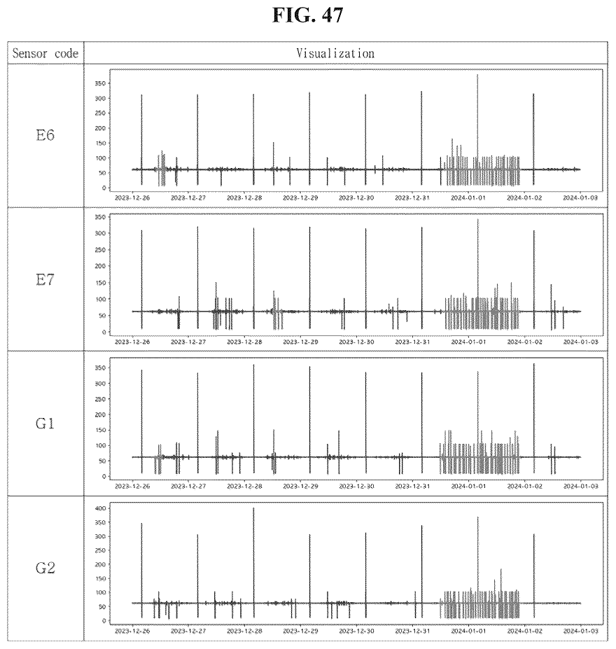

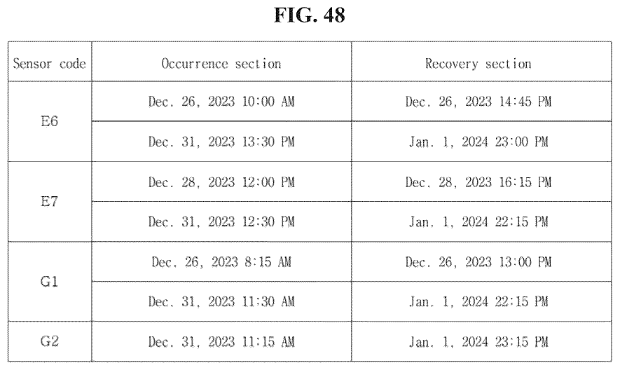

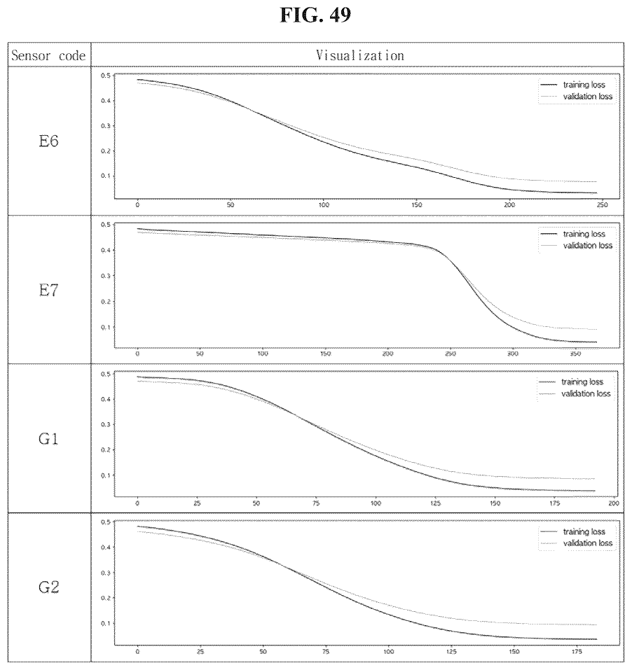

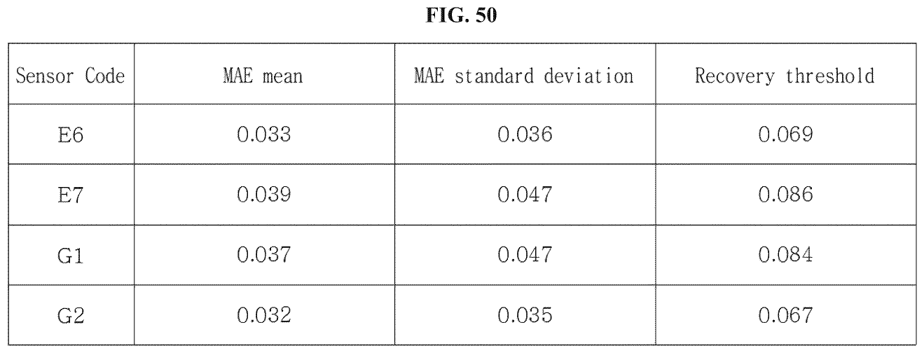

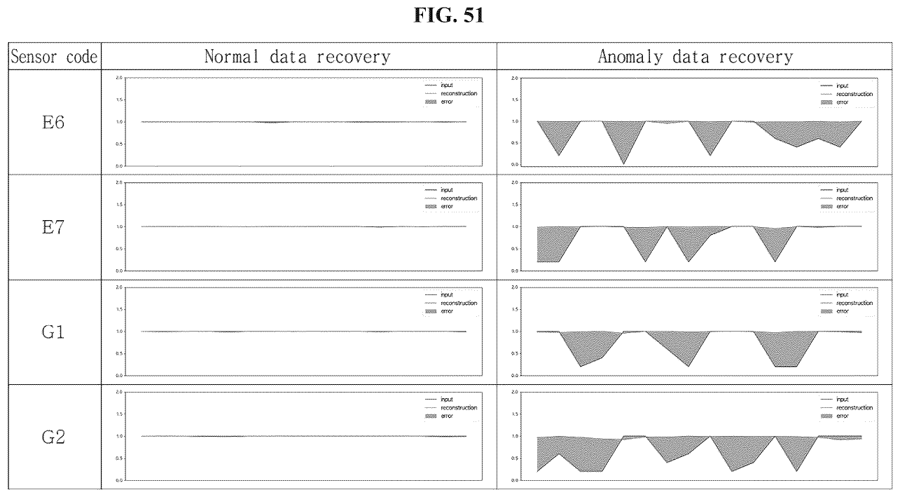

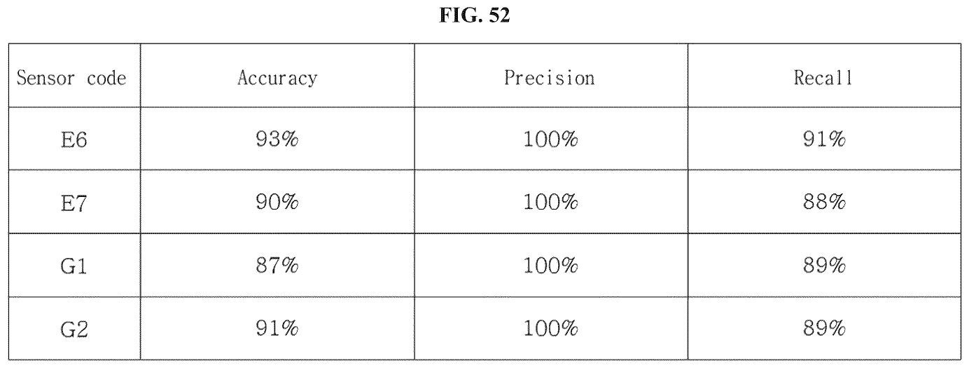

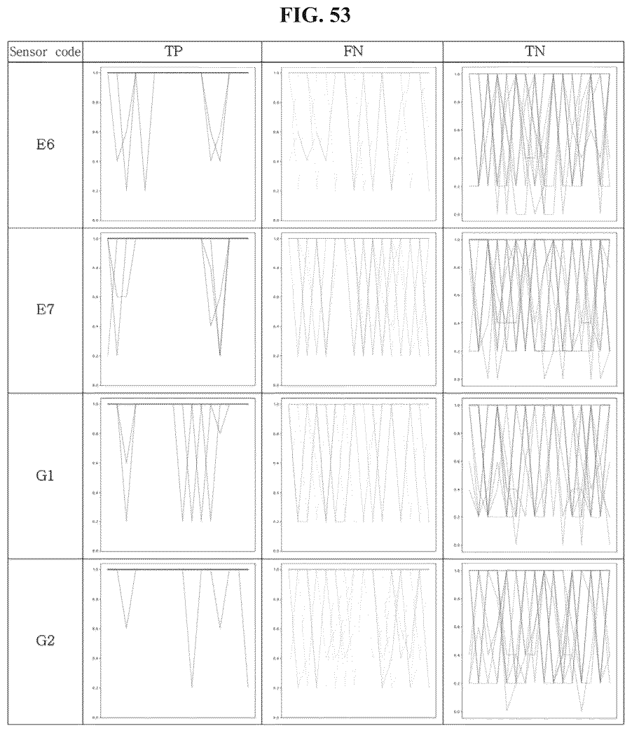

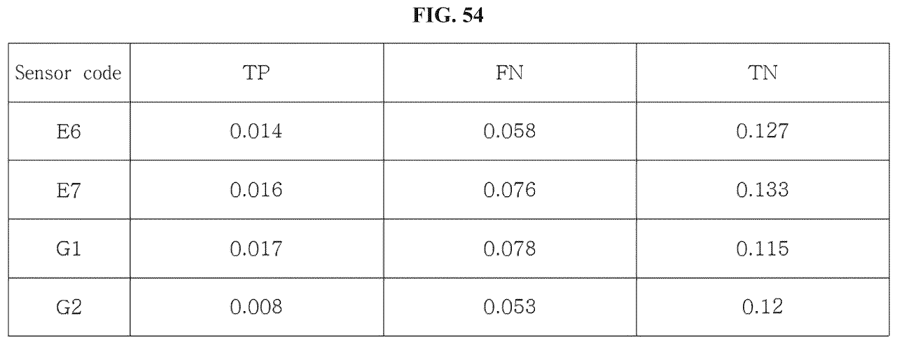

FIG. 44 is a diagram showing an example of preprocessing data in an unstable duration in the experimental environment shown in FIG. 43. FIG. 45 is a diagram showing an example of a sliding window main section in an unstable duration in an experimental environment according to an embodiment of the present disclosure. FIG. 46 is a diagram showing the degree of instability in an experimental environment according to an embodiment of the present disclosure. FIG. 47 is a diagram visualizing an anomaly period occurrence duration of statistical-based period filtering according to an embodiment of the present disclosure. FIG. 48 is a diagram expressing as text an anomaly period occurrence duration of statistical-based period filtering according to an embodiment of the present disclosure as text. FIG. 49 is a diagram showing an AutoEncoder learning evaluation according to an embodiment of the present disclosure. FIG. 50 is a diagram showing an example of recovery threshold setting values in an unstable duration according to an embodiment of the present disclosure. FIG. 51 is a diagram comparing normal and anomaly data recovery visualizations in an unstable duration according to an embodiment of the present disclosure. FIG. 52 is a diagram showing an example of classification metrics in an unstable duration according to an embodiment of the present disclosure. FIG. 53 is a diagram showing an example of patterns by cases in an unstable duration according to an embodiment of the present disclosure. FIG. 54 is a diagram showing average pattern variance values by cases in an unstable duration according to an embodiment of the present disclosure.

Referring to FIG. 44, it can be seen that the smoothing period data and the direction period data clearly show an anomaly period pattern in the unstable duration.

Referring to FIG. 45, it can be seen that the occurrence and recovery sections of major sliding windows according to the filtering process are different from each other in the unstable duration. Here, FIG. 45 shows the pattern data of each separated period classification of the statistical-based period filtering as minimum and maximum normalization.

Referring to FIG. 46, the degree of instability of the sensor data acquired in the experimental environment of FIG. 43 is visualized transparently in light color, and the average pattern is visualized in bold. As shown, it can be seen that the locations where the normal and anomaly periods of the sensors appear are different, and it can be seen that the irregular afterimages appear more boldly in the anomaly period. In addition, the location of the average pattern appears to have a tendency to maintain a specific value (e.g., a form biased toward the value of 1 or 0) in the case of the normal period, but in the case of the anomaly period, a pattern located near the center appears. This phenomenon means that the value changed several times in the anomaly period, and it implies that the statistical-based period filtering operation was performed smoothly.

Referring to FIG. 47, it can be seen that for each of the sensors (E6, E7, G1, and G2), the anomaly period detection model can detect an anomaly phenomenon section visible to the naked eye and even an anomaly phenomenon section with lower severity. Referring to FIG. 48, it can be seen that the anomaly period detection model can extract detailed information about occurrence time and recovery time.

Referring to FIGS. 49 to 54, the normal period separated through the process described in FIG. 33 above was input into the AutoEncoder, and learning was performed until there was no significant improvement in the performance measurement results of the validation data as shown in FIG. 49. Then, as shown in FIG. 50, recovery was performed on the test data, and a recovery threshold, which is the sum of the average and standard deviation of the mean absolute error between the test data and the recovery data, was set. The detection function was implemented using the recovery threshold.

After setting the recovery threshold, the normal period data and the anomaly period data for evaluation were merged to form the final evaluation data, and the classification metric performance evaluation according to the implemented detection function was performed. FIG. 52 shows the recovery difference between normal and anomaly as the classification performance evaluation result. Through accuracy, it can be seen that a case of false detection occurred, and through the numerical analysis of precision that was approached in detail, it can be seen that there was no case of false detection of anomaly data as normal. Through the numerical analysis of recall, it can be seen that there was a case of false detection for normal data as anomaly. In FIGS. 53 and 54, the patterns and average pattern variance values of correct normal detection (TP), incorrect anomaly detection (FN), and correct anomaly detection (TN) are listed by sensor.

From the results shown in FIGS. 53 and 54, it can be seen that the severity of anomaly phenomenon increases in the order of TP-FN-TN. Here, the FN case is a case that determines normal as anomaly while causing a decrease in recall and accuracy. In the results above, the FN case can be interpreted as a case where a relatively low-severity anomaly phenomenon among normal phenomena was detected as anomaly.

Through the above-described drawings, it can be interpreted as a false detection with the property of early detection and preemptive response before the severity of the anomaly phenomenon increases. When these results are combined with the results of high precision, it can be seen that the anomaly period detection model of the present disclosure has high accuracy and operational flexibility.

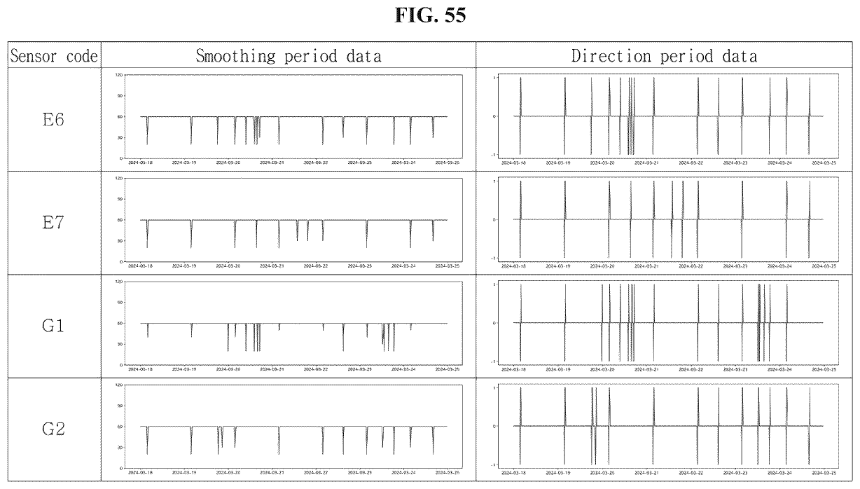

Hereinafter, the operation results of the anomaly detection model in the stable duration of the experimental environments described above will be described through FIGS. 55 to 61.

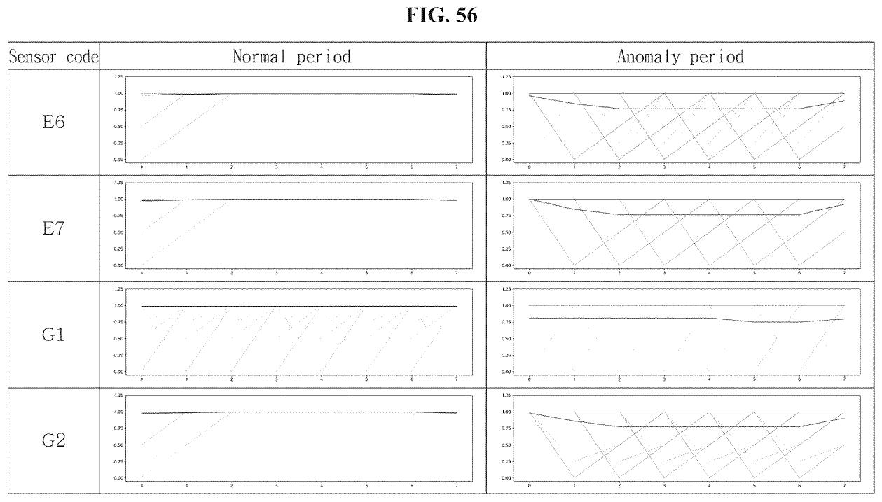

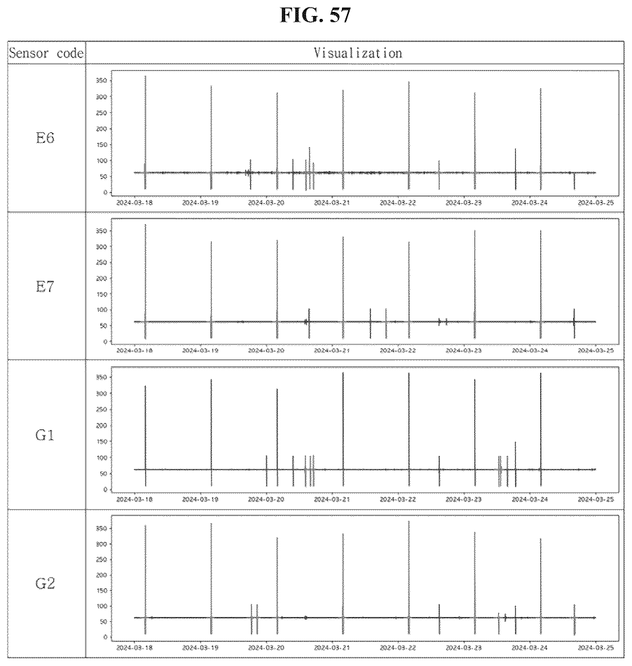

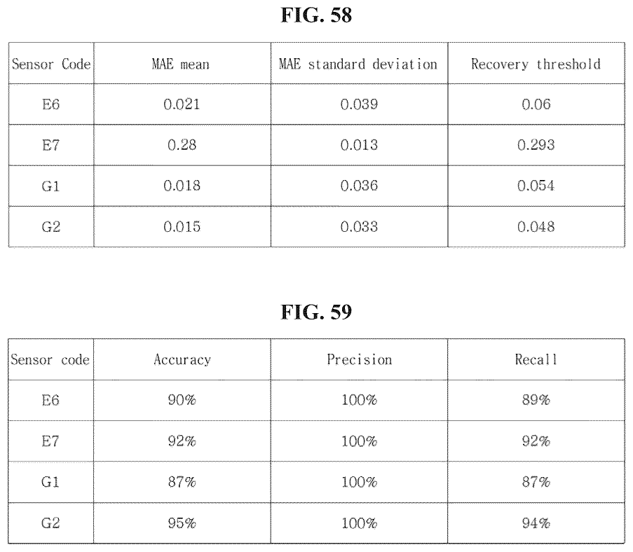

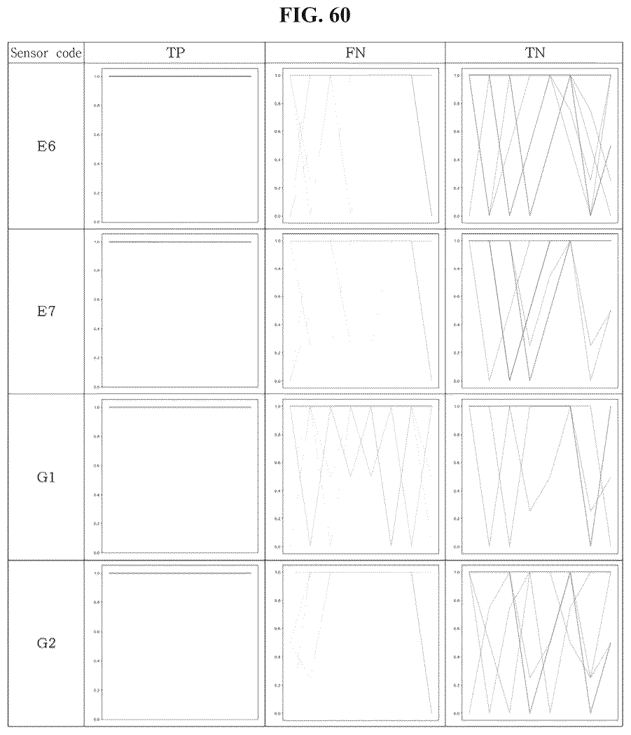

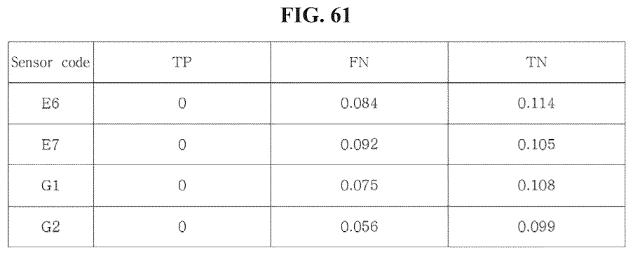

FIG. 55 is a diagram showing an example of preprocessing data in a stable duration in the experimental environment shown in FIG. 43. FIG. 56 is a diagram showing an example of a comparison of normal and anomaly period patterns in a stable duration in an experimental environment according to an embodiment of the present disclosure. FIG. 57 is a diagram showing an emphasis on anomaly period patterns in a stable duration in an experimental environments according to an embodiment of the present disclosure. FIG. 58 is a diagram showing an example of recovery threshold setting values in a stable duration according to an embodiment of the present disclosure. FIG. 59 is a diagram showing an example of classification metrics in a stable duration according to an embodiment of the present disclosure. FIG. 60 is a diagram showing an example of patterns by cases in a stable duration according to an embodiment of the present disclosure. FIG. 61 is a diagram showing average pattern variance values by cases in a stable duration according to an embodiment of the present disclosure.

Referring to FIGS. 55 to 61, in the experiment of the stable duration environment dataset, an anomaly phenomenon means a small amount of data that has characteristics different from normal in everyday situations. Therefore, an experiment in a stable environment, which is a general state of the actual environment, is required, and through this, the actual operability and reliability of the model can be verified.

In relation to hyper-parameter information in the stable duration environment, in the stable environment with few anomaly phenomena, it is necessary to set hyper-parameters so that the anomaly period detection model can be operated in detail, and it is desirable to increase the strength of separation through this. The results of the anomaly period detection process were obtained by setting the frequency (freq) to 00:15:00, the period to 8, and the next value (next) to 0.4, respectively.

In FIG. 56, it can be seen that the anomaly period maintains a constant height like the normal period rather than the middle in the case of the unstable environment. Referring to FIG. 57, the filtering result in the stable environment is desirable to complete labeling by sensitively responding to a period with a shallow anomaly phenomenon because the density of filtering is delicately adjusted.

Referring to FIGS. 58 and 59, as the results of recovery threshold setting and evaluation in the learning of the anomaly period detection model, it can be seen that the classification metrics show a phenomenon leading to a decrease in recall and a decrease in accuracy, similar to the unstable environment.

Referring to FIGS. 60 and 61, in the pattern analysis of TP, FN, and TN cases according to the classification metrics, a classification in the order of severity of the anomaly phenomenon was conducted, and since most period patterns have a consistent pattern as in the TP case unlike the unstable environment, the anomaly period detection model was trained by focusing on generalizing this. Accordingly, the difference in the visualization and average pattern variance values of FN and TN is not large, and it can be seen that the operation of a model with high intensity that is sensitive to period changes is possible. In other words, it can be seen that there is reliability in the actual operability of the anomaly period detection model of the present disclosure.

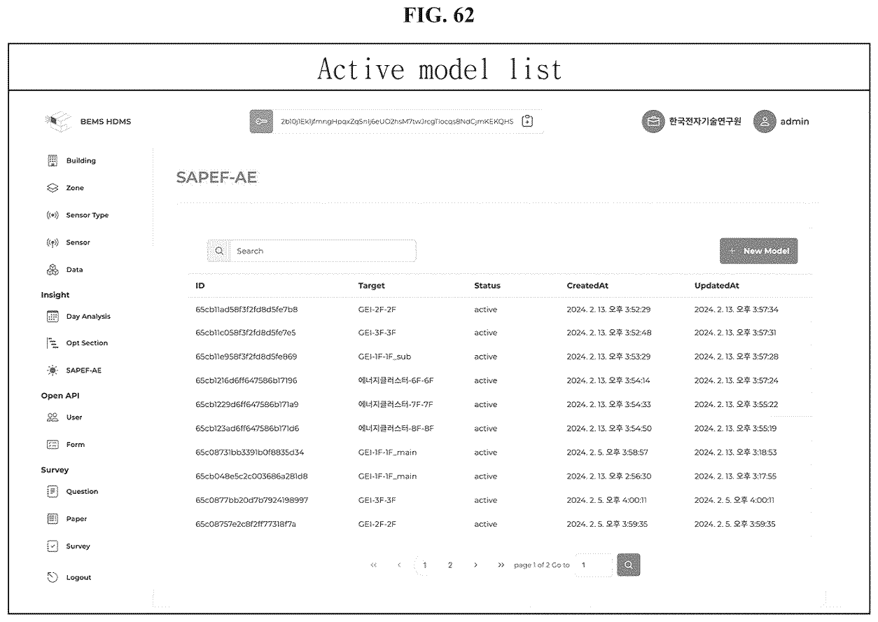

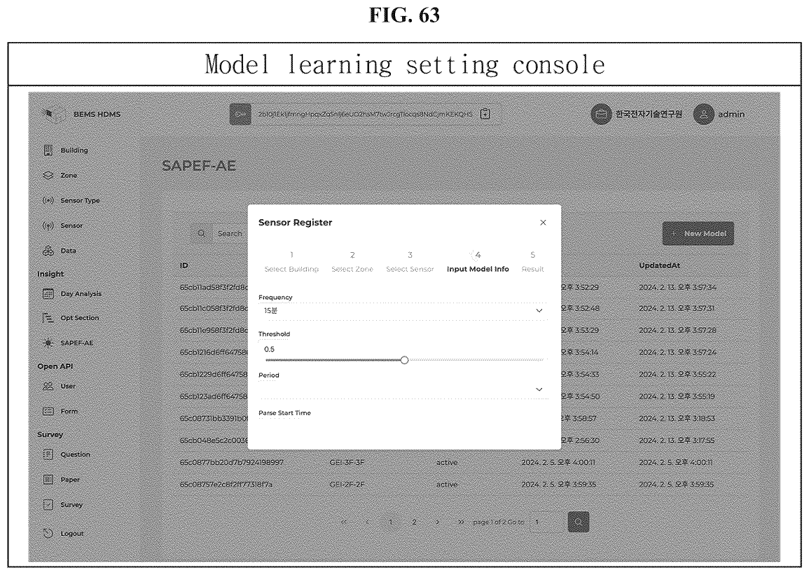

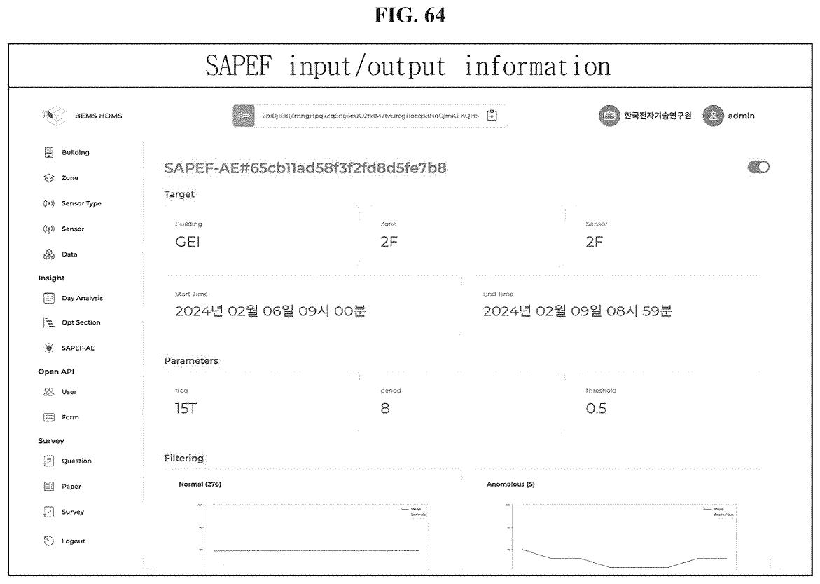

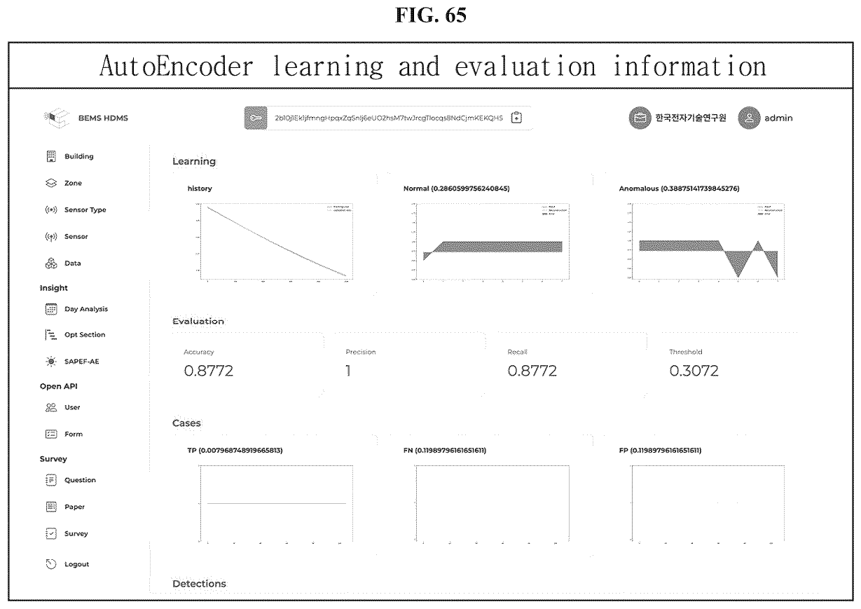

FIG. 62 is a diagram showing an active model list among actually applied screens of an anomaly period detection model according to an embodiment of the present disclosure. FIG. 63 is a diagram showing an example of a model learning setting console among actually applied screens of an anomaly period detection model according to an embodiment of the present disclosure. FIG. 64 is a diagram showing an example of a SAPEF input/output information screen among actually applied screens of an anomaly period detection model according to an embodiment of the present disclosure. FIG. 65 is a diagram showing an example of an AutoEncoder learning and evaluation information screen among actually applied screens of an anomaly period detection model according to an embodiment of the present disclosure.

Referring to FIGS. 1 to 62, the server device 320 may provide a screen supporting the anomaly period detection model for each of various sensors distinguished by their IDs to the administrator 11 through the user terminal 100. Referring to FIGS. 1 to 63, the server device 320 may provide a console screen related to model learning settings to the administrator 11 through the user terminal 100. Referring to FIGS. 1 to 64, the server device 320 may provide a screen including input/output information of the anomaly period detection model to the administrator 11 through the user terminal 100. Referring to FIGS. 1 to 65, the server device 320 may provide a screen including AutoEncoder learning and evaluation information to the administrator 11 through the user terminal 100.

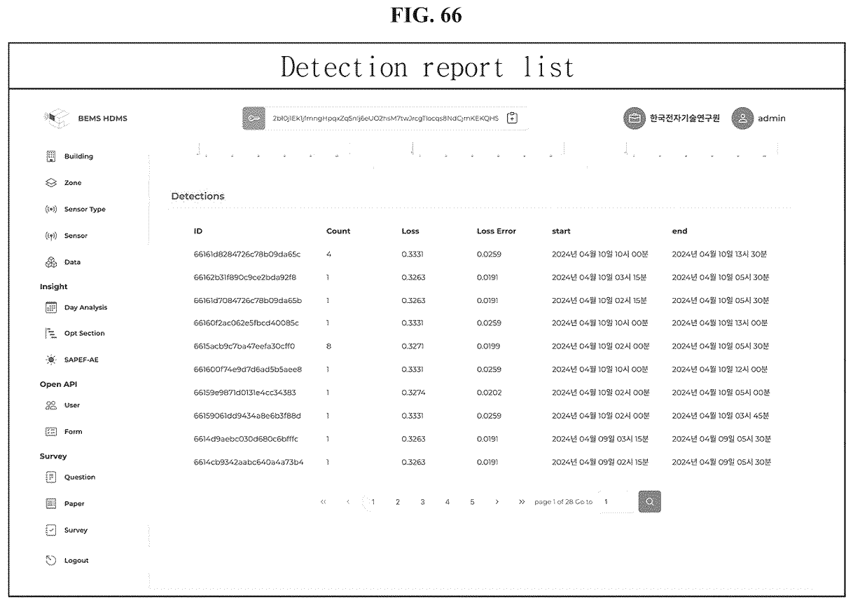

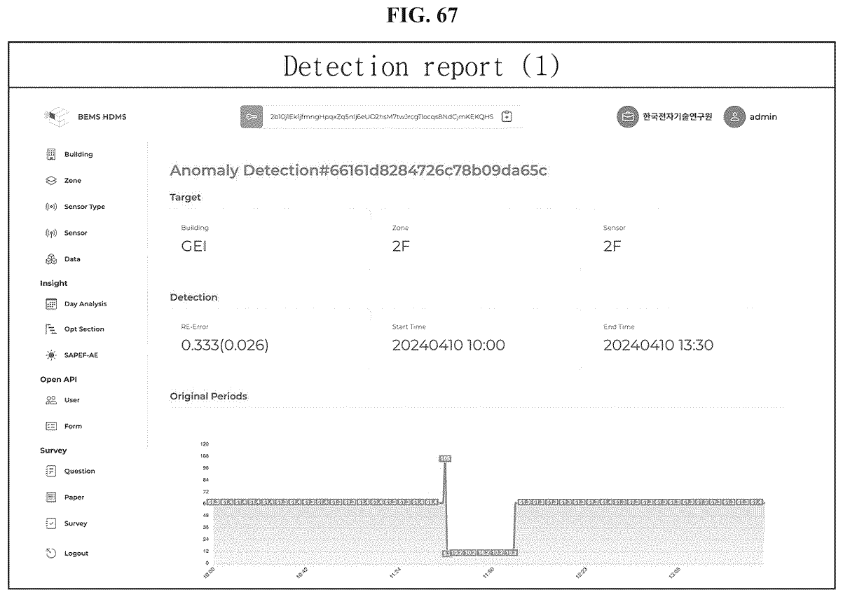

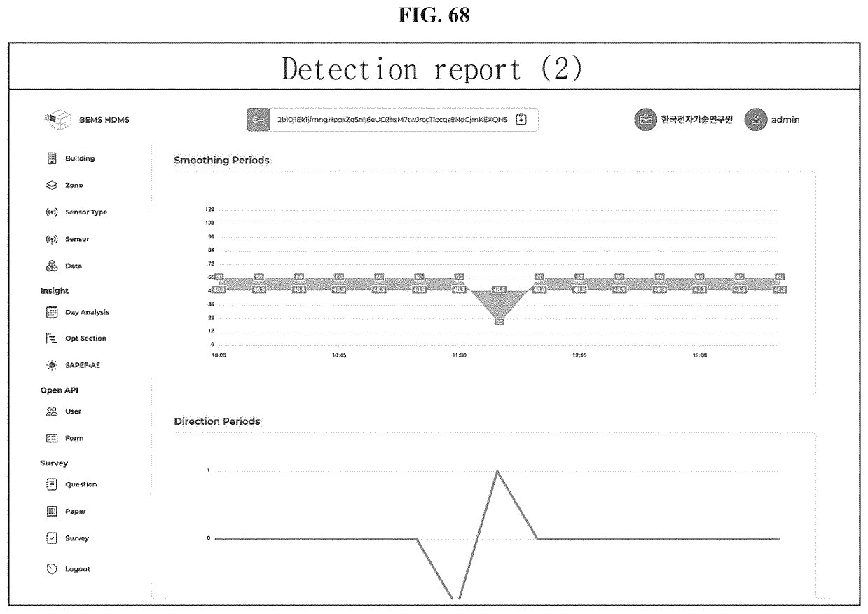

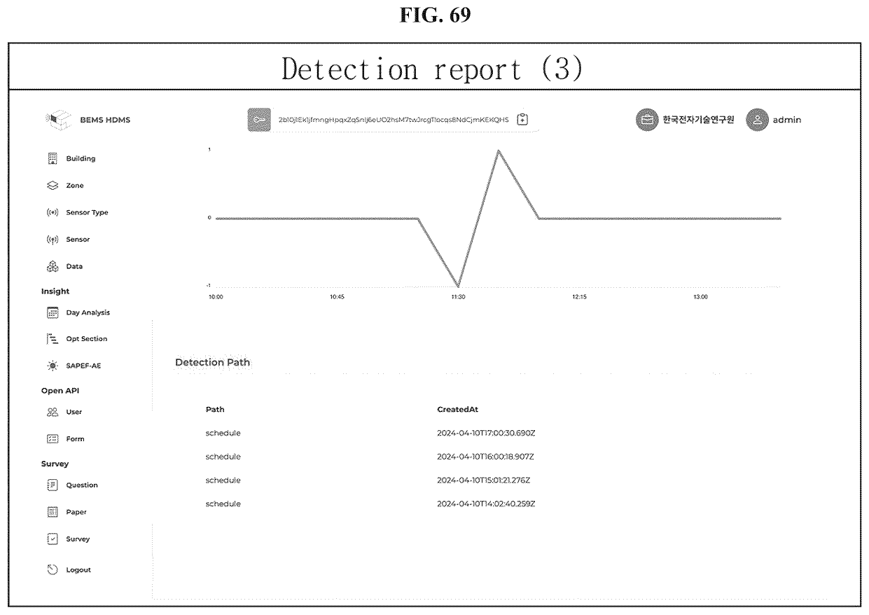

FIG. 66 is a diagram showing an example of a detection report list screen among actually applied screens of an anomaly period detection model according to an embodiment of the present disclosure. FIG. 67 is a diagram showing an example of a detection report screen among actually applied screens of an anomaly period detection model according to an embodiment of the present disclosure. FIG. 68 is a diagram showing another example of a detection report screen among actually applied screens of an anomaly period detection model according to an embodiment of the present disclosure. FIG. 69 is a diagram showing yet another example of a detection report screen among actually applied screens of an anomaly period detection model according to an embodiment of the present disclosure.

Referring to FIGS. 1 to 66, 67, 68, and 69, the server device 320 may provide at least one of a detection report list screen obtained through the operation of the anomaly period detection model as shown in FIG. 66, a first type detection report shown in FIG. 67, a second type detection report shown in FIG. 68, and a third type detection report shown in FIG. 69 to the administrator 11 through a user terminal 100.

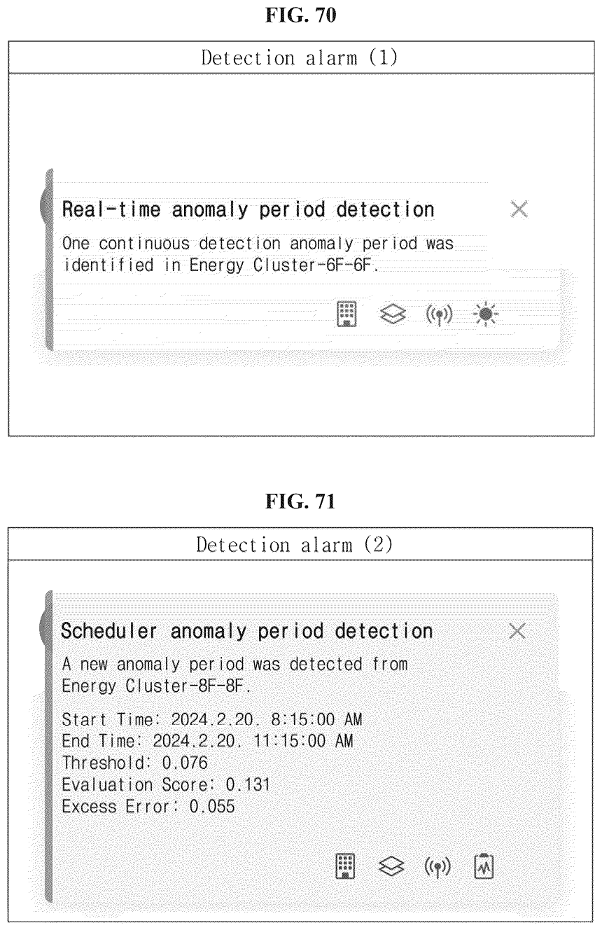

FIG. 70 is a diagram showing an example of a detection alarm screen among actually applied screens of an anomaly period detection model according to an embodiment of the present disclosure. FIG. 71 is a diagram showing another example of a detection alarm screen among actually applied screens of an anomaly period detection model according to an embodiment of the present disclosure.

Referring to FIGS. 1 to 70 and 71, when the server device 320 detects an anomaly period through the operation of the anomaly period detection model, it may provide a real-time anomaly period detection alarm screen to the administrator 11 through the user terminal 100 as shown in FIG. 70, or provide a scheduler anomaly period detection alarm screen to the administrator 11 through the user terminal 100 as shown in FIG. 71. The administrator 11 may recognize the occurrence of an anomaly in the sensor or the scheduler through the above-described alarm screens.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A server device supporting anomaly period detection, comprising:
a communication circuit configured to receive sensor data from a sensor;
a memory configured to store the received sensor data and an anomaly period detection model; and
at least one processor functionally connected to the communication circuit and the memory, the at least one processor configured to:
receive the sensor data from the sensor,
produce smoothing period data by performing preprocessing on the sensor data based on the anomaly period detection model corresponding to the sensor,
acquire recovery data by inputting the smoothing period data into the anomaly period detection model, and
determine a normal period pattern or an anomaly period pattern by comparing an error calculated between the smoothing period data and the recovery data with a predetermined threshold.

2. The server device of claim 1, wherein the at least one processor is configured to determine the threshold by summing up an average and a standard deviation of the errors between the smoothing period data and the recovery data, and
wherein the error includes a mean absolute error per element of a set of the recovery data and the smoothing period data.

3. The server device of claim 1, wherein the at least one processor is configured to determine a case where a value of the error is greater than the threshold as occurrence of the anomaly period pattern, and determine a case where the value of the error is less than the threshold as occurrence of the normal period pattern.

4. The server device of claim 3, wherein the at least one processor is configured to create a detection alarm message indicating the anomaly period pattern in response to the occurrence of the anomaly period pattern, and transmit the detection alarm message to a user terminal of an administrator who manages the sensor.

5. The server device of claim 1, wherein the at least one processor is configured to create a detection report on the anomaly period detection, and transmit the detection report to a user terminal of an administrator who manages the sensor.

6. The server device of claim 1, wherein the at least one processor is configured to perform a validity check on the sensor data, upon receiving the sensor data, and then store the sensor data in the memory.

7. An operating method of a server device supporting anomaly period detection, the method comprising:
receiving sensor data from a sensor;
producing smoothing period data by performing preprocessing on the sensor data based on an anomaly period detection model corresponding to the sensor;
acquiring recovery data by inputting the smoothing period data into the anomaly period detection model; and
determining a normal period pattern or an anomaly period pattern by comparing an error calculated between the smoothing period data and the recovery data with a predetermined threshold.

8. The method of claim 7, wherein the error includes a mean absolute error per element of a set of the recovery data and the smoothing period data, and
wherein the method further comprises determining the threshold by summing up an average and a standard deviation of the errors between the smoothing period data and the recovery data.

9. The method of claim 7, wherein the determining includes:
determining a case where a value of the error is greater than the threshold as occurrence of the anomaly period pattern; and
determining a case where the value of the error is less than the threshold as occurrence of the normal period pattern.

10. The method of claim 9, further comprising:
creating a detection alarm message indicating the anomaly period pattern in response to the occurrence of the anomaly period pattern; and
transmitting the detection alarm message to a user terminal of an administrator who manages the sensor.

11. The method of claim 7, further comprising:
creating a detection report on the anomaly period detection; and
transmitting the detection report to a user terminal of an administrator who manages the sensor.

12. The method of claim 7, further comprising:
performing a validity check on the sensor data, upon receiving the sensor data; and
subsequently storing the sensor data in the memory.
